(19) United States
(12) Patent Application Publication
(10) Pub. No.: US 2019/0160343 A1
(43) Pub. Date: May 30, 2019

(54) GOLF BALL

(71) Applicant: SUMITOMO RUBBER INDUSTRIES, LTD., Kobe-shi (JP)

(72) Inventors: Hironori TAKIHARA, Kobe-shi (JP); Takahiro SAJIMA, Kobe-shi (JP); Kohei MIMURA, Kobe-shi (JP)

(73) Assignee: SUMITOMO RUBBER INDUSTRIES, LTD., Kobe-shi (JP)

(21) Appl. No.: 16/175,466

(22) Filed: Oct. 30, 2018

(30) Foreign Application Priority Data
Nov. 29, 2017 (JP) 2017-229103

(51) Int. Cl. A63B 37/00

(52) U.S. Cl. CPC A63B 37/0076; A63B 37/0062; A63B 37/0064; A63B 37/0031; A63B 37/0033; B32B 1/00; A63B 37/0021; A63B 37/0087; A63B 37/0019; A63B 37/002; A63B 37/0017; A63B 37/0006

(57) ABSTRACT

A golf ball 2 has a core 4, an inner cover 6, a main cover 8, and an outer cover 10. A product TH2 of a thickness T2 (mm) and a Shore C hardness H2 of the main cover 8 and a product THs of a value of 5% of a radius (mm) of the core 4 and a Shore C hardness Hs at a surface of the core 4 satisfy the following mathematical formula.

15≤(TH2−THs)≤100

A product TH1 of a thickness T1 (mm) and a Shore C hardness H1 of the inner cover 6, a product TH3 of a thickness T3 (mm) and a Shore C hardness H3 of the outer cover 10, and the product TH2 satisfy the following mathematical formula.

0.25<((TH1+TH3)/2)/TH2<0.65

This application claims priority on Patent Application No. 2017-229103 filed in JAPAN on Nov. 29, 2017. The entire contents of this Japanese Patent Application are hereby incorporated by reference.

### BACKGROUND OF THE INVENTION

### Field of the Invention

The present invention relates to golf balls. Specifically, the present invention relates to golf balls having a core, an inner cover, a main cover, an outer cover, and dimples.

### Description of the Related Art

The greatest interest to golf players concerning golf balls is flight distance. Golf players particularly place importance on flight distances upon shots with drivers. Golf balls with which a large flight distance is achieved upon a shot with a driver can contribute to a good score.

JP2013-9916 discloses a golf ball having a core and a cover. The core is formed by crosslinking a rubber composition including a carboxylate. The core can contribute to a flight distance upon a shot with a driver.

JP2013-248262 discloses a golf ball having a core, an inner cover, and an outer cover. The core has a linear hardness distribution. The core can contribute to a flight distance upon a shot with a driver.

The face of a golf club has a loft angle. When a golf ball is hit with the golf club, the golf ball is launched at a launch angle corresponding to the loft angle. Furthermore, in the golf ball, backspin due to the loft angle occurs. The golf ball flies with the backspin.

Golf balls have a large number of dimples on the surfaces thereof. The dimples disturb the air flow around the golf ball during flight to cause turbulent flow separation. This phenomenon is referred to as “turbulization”. Due to the turbulization, separation points of the air from the golf ball shift backwards leading to a reduction of drag. The turbulization promotes the displacement between the separation point on the upper side and the separation point on the lower side of the golf ball, which results from the backspin, thereby enhancing the lift force that acts upon the golf ball. The reduction of drag and the enhancement of lift force are referred to as a “dimple effect”. Excellent dimples efficiently disturb the air flow. The excellent dimples produce a long flight distance. There have been various proposals for dimples.

JP50-8630 discloses a golf ball having a large number of dimple pairs each having a distance of less than 0.065 inches between a dimple and another dimple adjacent to this dimple. In the golf ball, a large number of dimples are densely arranged.

JP2013-153966 discloses a golf ball in which a large number of dimples are densely arranged and the sizes of the dimples are less varied. A similar golf ball is also disclosed in JP2015-24079.

Another interest to golf players concerning golf balls is feel at impact. Generally, golf players prefer soft feel at impact.

Golf players' requirements for golf balls have been increased more than ever. An object of the present invention is to provide a golf ball having excellent flight performance and feel at impact.

### SUMMARY OF THE INVENTION

A golf ball according to the present invention includes a core, an inner cover positioned outside the core, a main cover positioned outside the inner cover, and an outer cover positioned outside the main cover. A product TH2 of a thickness T2 (mm) and a Shore C hardness H2 of the main cover and a product THs of a value of 5% of a radius (mm) of the core and a Shore C hardness Hs at a surface of the core satisfy the following mathematical formula.

15≤(TH2−THs)≤100

A product TH1 of a thickness T1 (mm) and a Shore C hardness H1 of the inner cover, a product TH3 of a thickness T3 (mm) and a Shore C hardness H3 of the outer cover, and the product TH2 satisfy the following mathematical formula.

0.25<((TH1+TH3)/2)/TH2<0.65

The golf ball has a plurality of dimples on a surface thereof. A standard deviation Su of areas of all the dimples is not greater than 1.70 mm². A standard deviation Pd of distances L between dimples of all neighboring dimple pairs is less than 0.500 mm.

When the golf ball according to the present invention is hit with a driver, the main cover contributes to resilience performance, and the dimples contribute to aerodynamic characteristics. The golf ball has excellent flight performance. Since the main cover is interposed between the inner cover and the outer cover in the golf ball, soft feel at impact is achieved.

The thickness T2 is preferably equal to or larger than the thickness T1. The thickness T2 is preferably equal to or larger than the thickness T3.

The thickness T2 is preferably not less than 1.00 mm. The thickness T1 is preferably not greater than 1.00 mm. The thickness T3 is preferably not greater than 1.00 mm.

The hardness H2 is preferably not less than 93. The hardness H1 is preferably not greater than 70. The hardness H3 is preferably not greater than 70.

The standard deviation Su is preferably not greater than 1.50 mm². The standard deviation Pd is preferably not greater than 0.400 mm.

A ratio So of a sum of the areas of the dimples relative to a surface area of a phantom sphere of the golf ball is preferably not less than 78.0%.

A sum of volumes of all the dimples is preferably not less than 450 mm³ and not greater than 750 mm³.

Preferably, a dimple pattern of each hemisphere of a phantom sphere of the golf ball includes three units that are rotationally symmetrical to each other. A dimple pattern of each unit includes two small units that are mirror-symmetrical to each other.

### BRIEF DESCRIPTION OF THE DRAWINGS

FIG. 1 is a schematic cross-sectional view of a golf ball according to an embodiment of the present invention;

FIG. 2 is an enlarged plan view of the golf ball in FIG. 1;

FIG. 3 is a front view of the golf ball in FIG. 2;

FIG. 4 is a partially enlarged cross-sectional view of the golf ball in FIG. 1;

FIG. 5 is a partially enlarged view of the golf ball in FIGS. 2 and 3;

FIG. 6 is an explanatory diagram for the definition of neighboring dimples in the golf ball in FIGS. 2 and 3;

FIG. 7 is an explanatory diagram for the definition of neighboring dimples in the golf ball in FIGS. 2 and 3;

FIG. 8 is an explanatory diagram for the definition of neighboring dimples in the golf ball in FIGS. 2 and 3;

FIG. 9 is an explanatory diagram for the definition of neighboring dimples in the golf ball in FIGS. 2 and 3;

FIG. 10 is a plan view of a golf ball according to Example 2 of the present invention;

FIG. 11 is a front view of the golf ball in FIG. 10;

FIG. 12 is a plan view of a golf ball according to Example 3 of the present invention;

FIG. 13 is a front view of the golf ball in FIG. 12;

FIG. 14 is a plan view of a golf ball according to Example 4 of the present invention;

FIG. 15 is a front view of the golf ball in FIG. 14;

FIG. 16 is a plan view of a golf ball according to Comparative Example 1;

FIG. 17 is a front view of the golf ball in FIG. 16;

FIG. 18 is a plan view of a golf ball according to Comparative Example 2;

FIG. 19 is a front view of the golf ball in FIG. 18;

FIG. 20 is a plan view of a golf ball according to Example 5 of the present invention; and

FIG. 21 is a front view of the golf ball in FIG. 20.

### DESCRIPTION OF THE PREFERRED EMBODIMENTS

The following will describe in detail the present invention based on preferred embodiments with appropriate reference to the drawings.

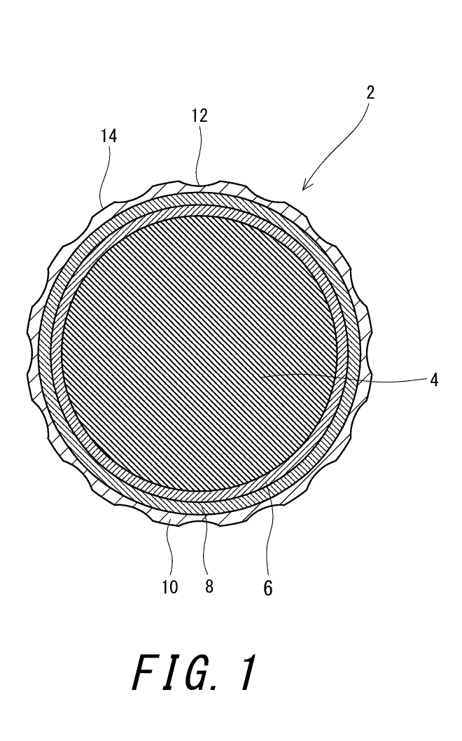

A golf ball 2 shown in FIG. 1 includes a spherical core 4, an inner cover 6 positioned outside the core 4, a main cover 8 positioned outside the inner cover 6, and an outer cover 10 positioned outside the main cover 8. The golf ball 2 has a plurality of dimples 12 on the surface thereof. Of the surface of the golf ball 2, a part other than the dimples 12 is a land 14. The golf ball 2 includes a paint layer and a mark layer on the external side of the outer cover 10, although these layers are not shown in the drawing.

The golf ball 2 preferably has a diameter of not less than 40 mm and not greater than 45 mm. From the viewpoint of conformity to the rules established by the United States Golf Association (USGA), the diameter is particularly preferably not less than 42.67 mm. In light of suppression of air resistance, the diameter is more preferably not greater than 44 mm and particularly preferably not greater than 42.80 mm.

The golf ball 2 preferably has a weight of not less than 40 g and not greater than 50 g. In light of attainment of great inertia, the weight is more preferably not less than 44 g and particularly preferably not less than 45.00 g. From the viewpoint of conformity to the rules established by the USGA, the weight is particularly preferably not greater than 45.93 g.

The core 4 is formed by crosslinking a rubber composition. Examples of preferable base rubbers for use in the rubber composition include polybutadienes, polyisoprenes, styrene-butadiene copolymers, ethylene-propylene-diene copolymers, and natural rubbers. In light of flight distance upon a shot with a driver having a low head speed, polybutadienes are preferable. When a polybutadiene and another rubber are used in combination, it is preferred if the polybutadiene is a principal component. Specifically, the proportion of the polybutadiene to the entire base rubber is preferably not less than 50% by weight and particularly preferably not less than 80% by weight. A polybutadiene in which the proportion of cis-1,4 bonds is not less than 80% is particularly preferable.

The rubber composition of the core 4 preferably includes a co-crosslinking agent. Preferable co-crosslinking agents in light of durability and resilience performance of the golf ball 2 are monovalent or bivalent metal salts of an α,β-unsaturated carboxylic acid having 2 to 8 carbon atoms. Examples of preferable co-crosslinking agents include zinc acrylate, magnesium acrylate, zinc methacrylate, and magnesium methacrylate. In light of durability and resilience performance of the golf ball 2, zinc acrylate and zinc methacrylate are particularly preferable.

The rubber composition may include a metal oxide and an α,β-unsaturated carboxylic acid having 2 to 8 carbon atoms. They both react with each other in the rubber composition to obtain a salt. The salt serves as a co-crosslinking agent. Examples of preferable α,β-unsaturated carboxylic acids include acrylic acid and methacrylic acid. Examples of preferable metal oxides include zinc oxide and magnesium oxide.

The amount of the co-crosslinking agent per 100 parts by weight of the base rubber is preferably not less than 10 parts by weight and not greater than 45 parts by weight. The golf ball 2 in which this amount is not less than 10 parts by weight has excellent resilience performance. From this viewpoint, this amount is more preferably not less than 15 parts by weight and particularly preferably not less than 20 parts by weight. The golf ball 2 in which this amount is not greater than 45 parts by weight has excellent feel at impact. From this viewpoint, this amount is more preferably not greater than 40 parts by weight and particularly preferably not greater than 35 parts by weight.

Preferably, the rubber composition of the core 4 includes an organic peroxide. The organic peroxide serves as a crosslinking initiator. The organic peroxide contributes to the durability and the resilience performance of the golf ball 2. Examples of suitable organic peroxides include dicumyl peroxide, 1,1-bis(t-butylperoxy)-3,3,5-trimethylcyclohexane, 2,5-dimethyl-2,5-di(t-butylperoxy)hexane, and di-t-butyl peroxide. An organic peroxide with particularly high versatility is dicumyl peroxide.

The amount of the organic peroxide per 100 parts by weight of the base rubber is preferably not less than 0.1 parts by weight and not greater than 3.0 parts by weight. The golf ball 2 in which this amount is not less than 0.1 parts by weight has excellent resilience performance. From this viewpoint, this amount is more preferably not less than 0.3 parts by weight and particularly preferably not less than 0.5 parts by weight. The golf ball 2 in which this amount is not greater than 3.0 parts by weight has excellent feel at impact. From this viewpoint, this amount is more preferably not greater than 2.5 parts by weight and particularly preferably not greater than 2.0 parts by weight.

Preferably, the rubber composition of the core 4 includes an organic sulfur compound. The organic sulfur compound contributes to flight distance upon a shot with a driver. Organic sulfur compounds include naphthalenethiol compounds, benzenethiol compounds, and disulfide compounds.

Examples of naphthalenethiol compounds include 1-naphthalenethiol, 2-naphthalenethiol, 4-chloro-1-naphthalenethiol, 4-bromo-1-naphthalenethiol, 1-chloro-2-naphthalenethiol, 1-bromo-2-naphthalenethiol, 1-fluoro-2-naphthalenethiol, 1-cyano-2-naphthalenethiol, and 1-acetyl-2-naphthalenethiol.

Examples of benzenethiol compounds include benzenethiol, 4-chlorobenzenethiol, 3-chlorobenzenethiol, 4-bromobenzenethiol, 3-bromobenzenethiol, 4-fluorobenzenethiol, 4-iodobenzenethiol, 2,5-dichlorobenzenethiol, 3,5-dichlorobenzenethiol, 2,6-dichlorobenzenethiol, 2,5-dibromobenzenethiol, 3,5-dibromobenzenethiol, 2-chloro-5-bromobenzenethiol, 2,4,6-trichlorobenzenethiol, 2,3,4,5,6-pentachlorobenzenethiol, 2,3,4,5,6-pentafluorobenzenethiol, 4-cyanobenzenethiol, 2-cyanobenzenethiol, 4-nitrobenzenethiol, and 2-nitrobenzenethiol.

Examples of disulfide compounds include diphenyl disulfide, bis(4-chlorophenyl)disulfide, bis(3-chlorophenyl)disulfide, bis(4-bromophenyl)disulfide, bis(3-bromophenyl)disulfide, bis(4-fluorophenyl)disulfide, bis(4-iodophenyl)disulfide, bis(4-cyanophenyl)disulfide, bis(2,5-dichlorophenyl)disulfide, bis(3,5-dichlorophenyl)disulfide, bis(2,6-dichlorophenyl)disulfide, bis(2,5-dibromophenyl)disulfide, bis(3,5-dibromophenyl)disulfide, bis(2-chloro-5-bromophenyl)disulfide, bis(2-cyano-5-bromophenyl)disulfide, bis(2,4,6-trichlorophenyl)disulfide, bis(2-cyano-4-chloro-6-bromophenyl)disulfide, bis(2,3,5,6-tetrachlorophenyl)disulfide, bis(2,3,4,5,6-pentachlorophenyl)disulfide, and bis(2,3,4,5,6-pentabromophenyl)disulfide.

In light of resilience performance, the amount of the organic sulfur compound per 100 parts by weight of the base rubber is preferably not less than 0.1 parts by weight, more preferably not less than 0.2 parts by weight, and particularly preferably not less than 0.3 parts by weight. In light of soft feel at impact, the amount is preferably not greater than 1.5 parts by weight, more preferably not greater than 1.0 parts by weight, and particularly preferably not greater than 0.8 parts by weight. Two or more organic sulfur compounds may be used in combination.

Preferably, the rubber composition of the core 4 includes a carboxylic acid or a carboxylate. The carboxylic acid and the carboxylate can contribute to making the hardness distribution of the core 4 appropriate. An example of preferable carboxylic acids is benzoic acid. Examples of preferable carboxylates include zinc octoate and zinc stearate. The amount of the carboxylic acid and the carboxylate per 100 parts by weight of the base rubber is preferably not less than 0.5 parts by weight, more preferably not less than 0.8 parts by weight, and particularly preferably not less than 1.0 part by weight. This amount is preferably not greater than 20 parts by weight, more preferably not greater than 15 parts by weight, and particularly preferably not greater than 10 parts by weight.

The rubber composition of the core 4 may include a filler for the purpose of specific gravity adjustment and the like. Examples of suitable fillers include zinc oxide, barium sulfate, calcium carbonate, and magnesium carbonate. The amount of the filler is determined as appropriate so that the intended specific gravity of the core 4 is accomplished.

The rubber composition of the core 4 may include various additives, such as sulfur, an anti-aging agent, a coloring agent, a plasticizer, a dispersant, and the like, in an adequate amount. The rubber composition may include crosslinked rubber powder or synthetic resin powder.

The core 4 preferably has a diameter of not less than 35.0 mm and not greater than 40.5 mm. The golf ball 2 that includes the core 4 having a diameter of not less than 35.0 mm has excellent resilience performance. From this viewpoint, the diameter is more preferably not less than 36.0 mm and particularly preferably not less than 36.5 mm. The golf ball 2 that includes the core 4 having a diameter of not greater than 40.5 mm has excellent durability. From this viewpoint, the diameter is more preferably not greater than 39.5 mm and particularly preferably not greater than 39.0 mm.

A hardness Ho at the central point of the core 4 is preferably not less than 35 and not greater than 70. The golf ball 2 in which the hardness Ho is not less than 35 has excellent resilience performance. From this viewpoint, the hardness Ho is more preferably not less than 40 and particularly preferably not less than 45. The golf ball 2 in which the hardness Ho is not greater than 70 has excellent feel at impact. From this viewpoint, the hardness Ho is more preferably not greater than 65 and particularly preferably not greater than 60.

The hardness Ho is measured with a Shore C type hardness scale mounted to an automated hardness meter (trade name “digi test II” manufactured by Heinrich Bareiss Prüfgerätebau GmbH). The hardness scale is pressed against the central point of the cross-section of a hemisphere obtained by cutting the golf ball 2. The measurement is conducted in an environment of 23° C.

A hardness Hs at the surface of the core 4 is preferably not less than 55 and not greater than 95. The golf ball 2 in which the hardness Hs is not less than 55 has excellent resilience performance. From this viewpoint, the hardness Hs is more preferably not less than 60 and particularly preferably not less than 65. The golf ball 2 in which the hardness Hs is not greater than 95 has excellent feel at impact. From this viewpoint, the hardness Hs is more preferably not greater than 90 and particularly preferably not greater than 85.

The hardness Hs is measured with a Shore C type hardness scale mounted to an automated hardness meter (trade name “digi test II” manufactured by Heinrich Bareiss Prüfgerätebau GmbH). The hardness scale is pressed against the surface of the core 4. The measurement is conducted in an environment of 23° C.

A product THs of a value of 5% of the radius (mm) of the core 4 and the Shore C hardness Hs at the surface of the core 4 is preferably not less than 55 and not greater than 90. The golf ball 2 in which the product THs is not less than 55 has excellent resilience performance. From this viewpoint, the product THs is more preferably not less than 60 and particularly preferably not less than 65. The golf ball 2 in which the product THs is not greater than 90 has excellent feel at impact. From this viewpoint, the product THs is more preferably not greater than 85 and particularly preferably not greater than 80.

The core 4 has a weight of preferably not less than 10 g and not greater than 42 g. The temperature for crosslinking the core 4 is not lower than 140° C. and not higher than 180° C. The time period for crosslinking the core 4 is not shorter than 10 minutes and not longer than 60 minutes.

The inner cover 6 is positioned outside the core 4. The inner cover 6 is formed from a thermoplastic resin composition. Examples of the base polymer of the resin composition include ionomer resins, thermoplastic polyester elastomers, thermoplastic polyamide elastomers, thermoplastic polyurethane elastomers, thermoplastic polyolefin elastomers, and thermoplastic polystyrene elastomers. Ionomer resins are particularly preferable. Ionomer resins are highly elastic. The golf ball 2 that includes the inner cover 6 including an ionomer resin has excellent resilience performance. The golf ball 2 has excellent flight distance upon a shot with a driver.

An ionomer resin and another resin may be used in combination. In this case, in light of resilience performance, the ionomer resin is included as the principal component of the base polymer. The proportion of the ionomer resin to the entire base polymer is preferably not less than 50% by weight.

Examples of preferable ionomer resins include binary copolymers formed with an α-olefin and an α,β-unsaturated carboxylic acid having 3 to 8 carbon atoms. A preferable binary copolymer includes 80% by weight or more but 90% by weight or less of an α-olefin, and 10% by weight or more but 20% by weight or less of an α,β-unsaturated carboxylic acid. The binary copolymer has excellent resilience performance. Examples of other preferable ionomer resins include ternary copolymers formed with: an α-olefin; an α,β-unsaturated carboxylic acid having 3 to 8 carbon atoms; and an α,β-unsaturated carboxylate ester having 2 to 22 carbon atoms. A preferable ternary copolymer includes 70% by weight or more but 85% by weight or less of an α-olefin, 5% by weight or more but 30% by weight or less of an α,β-unsaturated carboxylic acid, and 1% by weight or more but 25% by weight or less of an α,β-unsaturated carboxylate ester. The ternary copolymer has excellent resilience performance. For the binary copolymer and the ternary copolymer, preferable α-olefins are ethylene and propylene, while preferable α,β-unsaturated carboxylic acids are acrylic acid and methacrylic acid. A particularly preferable ionomer resin is a copolymer formed with ethylene and acrylic acid. Another particularly preferable ionomer resin is a copolymer formed with ethylene and methacrylic acid.

In the binary copolymer and the ternary copolymer, some of the carboxyl groups are neutralized with metal ions. Examples of metal ions for use in neutralization include sodium ion, potassium ion, lithium ion, zinc ion, calcium ion, magnesium ion, aluminum ion, and neodymium ion. The neutralization may be carried out with two or more types of metal ions. Particularly suitable metal ions in light of resilience performance and durability of the golf ball 2 are sodium ion, zinc ion, lithium ion, and magnesium ion.

Specific examples of ionomer resins include trade names “Himilan 1555”, “Himilan 1557”, “Himilan 1605”, “Himilan 1706”, “Himilan 1707”, “Himilan 1856”, “Himilan 1855”, “Himilan AM7311”, “Himilan AM7315”, “Himilan AM7317”, “Himilan AM7329”, and “Himilan AM7337”, manufactured by Du Pont-MITSUI POLYCHEMICALS Co., Ltd.; trade names “Surlyn 6120”, “Surlyn 6910”, “Surlyn 7930”, “Surlyn 7940”, “Surlyn 8140”, “Surlyn 8150”, “Surlyn 8940”, “Surlyn 8945”, “Surlyn 9120”, “Surlyn 9150”, “Surlyn 9910”, “Surlyn 9945”, “Surlyn AD8546”, “HPF1000”, and “HPF2000”, manufactured by E.I. du Pont de Nemours and Company; and trade names “IOTEK 7010”, “IOTEK 7030”, “IOTEK 7510”, “IOTEK 7520”, “IOTEK 8000”, and “IOTEK 8030”, manufactured by ExxonMobil Chemical Corporation. Two or more ionomer resins may be used in combination.

Preferably, the resin composition of the inner cover 6 includes a styrene block-containing thermoplastic elastomer. The styrene block-containing thermoplastic elastomer includes a polystyrene block as a hard segment, and a soft segment. A typical soft segment is a diene block. Examples of compounds for the diene block include butadiene, isoprene, 1,3-pentadiene, and 2,3-dimethyl-1,3-butadiene. Butadiene and isoprene are preferable. Two or more compounds may be used in combination.

Examples of styrene block-containing thermoplastic elastomers include styrene-butadiene-styrene block copolymers (SBS), styrene-isoprene-styrene block copolymers (SIS), styrene-isoprene-butadiene-styrene block copolymers (SIBS), hydrogenated SBS, hydrogenated SIS, and hydrogenated SIBS. Examples of hydrogenated SBS include styrene-ethylene-butylene-styrene block copolymers (SEBS). Examples of hydrogenated SIS include styrene-ethylene-propylene-styrene block copolymers (SEPS). Examples of hydrogenated SIBS include styrene-ethylene-ethylene-propylene-styrene block copolymers (SEEPS).

In light of resilience performance of the golf ball 2, the content of the styrene component in the styrene block-containing thermoplastic elastomer is preferably not less than 10% by weight, more preferably not less than 12% by weight, and particularly preferably not less than 15% by weight. In light of feel at impact of the golf ball 2, the content is preferably not greater than 50% by weight, more preferably not greater than 47% by weight, and particularly preferably not greater than 45% by weight.

In the present invention, styrene block-containing thermoplastic elastomers include an alloy of an olefin and one or more members selected from the group consisting of SBS, SIS, SIBS, SEBS, SEPS, and SEEPS. The olefin component in the alloy is presumed to contribute to improvement of compatibility with another base polymer. The alloy can contribute to the resilience performance of the golf ball 2. An olefin having 2 to 10 carbon atoms is preferable. Examples of suitable olefins include ethylene, propylene, butene, and pentene. Ethylene and propylene are particularly preferable.

Specific examples of polymer alloys include trade names “RABALON T3221C”, “RABALON T3339C”, “RABALON SJ4400N”, “RABALON SJ5400N”, “RABALON SJ6400N”, “RABALON SJ7400N”, “RABALON SJ8400N”, “RABALON SJ9400N”, and “RABALON SR04”, manufactured by Mitsubishi Chemical Corporation. Other specific examples of styrene block-containing thermoplastic elastomers include trade name “Epofriend A1010” manufactured by Daicel Chemical Industries, Ltd., and trade name “SEPTON HG-252” manufactured by Kuraray Co., Ltd.

In light of feel at impact, the proportion of the styrene block-containing thermoplastic elastomer to the entire base polymer is preferably not less than 10% by weight, more preferably not less than 15% by weight, and particularly preferably not less than 20% by weight. In light of resilience performance, this proportion is preferably not greater than 50% by weight.

The resin composition of the inner cover 6 may include a coloring agent, a filler, a dispersant, an antioxidant, an ultraviolet absorber, a light stabilizer, a fluorescent material, a fluorescent brightener, and the like in an adequate amount. When the hue of the golf ball 2 is white, a typical coloring agent is titanium dioxide.

The inner cover 6 preferably has a thickness T1 of not less than 0.50 mm and not greater than 1.30 mm. The golf ball 2 in which the thickness T1 is not less than 0.50 mm has excellent feel at impact. From this viewpoint, the thickness T1 is more preferably not less than 0.70 mm and particularly preferably not less than 0.80 mm. The golf ball 2 in which the thickness T1 is not greater than 1.30 mm has excellent resilience performance. From this viewpoint, the thickness T1 is more preferably not greater than 1.10 mm and particularly preferably not greater than 1.00 mm. The thickness is measured at a position immediately below the land 14.

The inner cover 6 preferably has a hardness H1 of not less than 45 and not greater than 75. The golf ball 2 in which the hardness H1 is not less than 45 has excellent resilience performance. From this viewpoint, the hardness H1 is more preferably not less than 50 and particularly preferably not less than 55. The golf ball 2 in which the hardness H1 is not greater than 75 has excellent feel at impact. From this viewpoint, the hardness H1 is more preferably not greater than 70 and particularly preferably not greater than 65.

The hardness H1 of the inner cover 6 is measured according to the standards of “ASTM-D 2240-68”. The hardness H1 is measured with a Shore C type hardness scale mounted to an automated hardness meter (trade name “digi test II” manufactured by Heinrich Bareiss Pridfgeratebau GmbH). For the measurement, a sheet that is formed by hot press, is formed from the same material as that of the inner cover 6, and has a thickness of about 2 mm is used. Prior to the measurement, a sheet is kept at 23° C. for two weeks. At the time of measurement, three sheets are stacked.

A product TH1 of the thickness T1 (mm) and the Shore C hardness H1 of the inner cover 6 is preferably not less than 25 and not greater than 75. The golf ball 2 in which the product TH1 is in this range has excellent resilience performance and feel at impact. From this viewpoint, the product TH1 is more preferably not less than 30 and not greater than 70, and particularly preferably not less than 35 and not greater than 65.

The main cover 8 is positioned outside the inner cover 6. The main cover 8 is formed from a thermoplastic resin composition. Examples of the base polymer of the resin composition include ionomer resins, thermoplastic polyester elastomers, thermoplastic polyamide elastomers, thermoplastic polyurethane elastomers, thermoplastic polyolefin elastomers, and thermoplastic polystyrene elastomers. Ionomer resins are particularly preferable. Ionomer resins are highly elastic. The golf ball 2 that includes the main cover 8 including an ionomer resin has excellent resilience performance. The golf ball 2 has excellent flight distance upon a shot with a driver. The ionomer resin described above for the inner cover 6 can be used for the main cover 8.

An ionomer resin and another resin may be used in combination. In this case, in light of resilience performance, the ionomer resin is included as the principal component of the base polymer. The proportion of the ionomer resin to the entire base polymer is preferably not less than 50% by weight, more preferably not less than 70% by weight, and particularly preferably not less than 80% by weight.

The resin composition of the main cover 8 may include a coloring agent, a filler, a dispersant, an antioxidant, an ultraviolet absorber, a light stabilizer, a fluorescent material, a fluorescent brightener, and the like in an adequate amount. When the hue of the golf ball 2 is white, a typical coloring agent is titanium dioxide.

The main cover 8 preferably has a thickness T2 of not less than 0.80 mm and not greater than 2.00 mm. The golf ball 2 in which the thickness T2 is not less than 0.80 mm has excellent resilience performance, and spin of the golf ball 2 is suppressed. The golf ball 2 has excellent flight performance. From this viewpoint, the thickness T2 is more preferably not less than 0.90 mm and particularly preferably not less than 1.00 mm. The golf ball 2 in which the thickness T2 is not greater than 2.00 mm has excellent feel at impact. From this viewpoint, the thickness T2 is more preferably not greater than 1.80 mm and particularly preferably not greater than 1.60 mm. The thickness is measured at a position immediately below the land 14.

The main cover 8 preferably has a hardness H2 of not less than 93 and not greater than 100. The golf ball 2 in which the hardness H2 is not less than 93 has excellent resilience performance, and spin of the golf ball 2 is suppressed. The golf ball 2 has excellent flight performance. From this viewpoint, the hardness H2 is more preferably not less than 95 and particularly preferably not less than 97. The golf ball 2 in which the hardness H2 is not greater than 100 has excellent feel at impact. From this viewpoint, the hardness H2 is more preferably not greater than 99 and particularly preferably not greater than 98.

The hardness H2 of the main cover 8 is measured according to the standards of “ASTM-D 2240-68”. The hardness H2 is measured with a Shore C type hardness scale mounted to an automated hardness meter (trade name “digi test II” manufactured by Heinrich Bareiss Prüfgerätebau GmbH). For the measurement, a sheet that is formed by hot press, is formed from the same material as that of the main cover 8, and has a thickness of about 2 mm is used. Prior to the measurement, a sheet is kept at 23° C. for two weeks. At the time of measurement, three sheets are stacked.

A product TH2 of the thickness T2 (mm) and the Shore C hardness H2 of the main cover 8 is preferably not less than 70 and not greater than 180. The golf ball 2 in which the product TH2 is in this range has excellent flight performance and feel at impact. From this viewpoint, the product TH2 is more preferably not less than 80 and not greater than 170, and particularly preferably not less than 90 and not greater than 160.

The outer cover 10 is the outermost layer except the mark layer and the paint layer. The outer cover 10 is formed from a resin composition. Examples of the base polymer of the resin composition include polyurethanes, ionomer resins, polyesters, polyamides, polyolefins, and polystyrenes. A preferable base polymer in light of feel at impact and spin performance is a polyurethane. When a polyurethane and another resin are used in combination for the outer cover 10, the proportion of the polyurethane to the entire base resin is preferably not less than 50% by weight, more preferably not less than 60% by weight, and particularly preferably not less than 70% by weight.

The resin composition of the outer cover 10 may include a thermoplastic polyurethane or may include a thermosetting polyurethane. In light of productivity of the golf ball 2, the thermoplastic polyurethane is preferable. The thermoplastic polyurethane includes a polyurethane component as a hard segment, and a polyester component or a polyether component as a soft segment. The thermoplastic polyurethane is flexible. The outer cover 10 in which the polyurethane is used has excellent scuff resistance.

The thermoplastic polyurethane has a urethane bond within the molecule. The urethane bond can be formed by reacting a polyol with a polyisocyanate. The polyol, as a material for the urethane bond, has a plurality of hydroxyl groups. Low-molecular-weight polyols and high-molecular-weight polyols can be used.

Examples of low-molecular-weight polyols include diols, triols, tetraols, and hexaols. Specific examples of diols include ethylene glycol, diethylene glycol, triethylene glycol, 1,2-propanediol, 1,3-propanediol, 2-methyl-1,3-propanediol, dipropylene glycol, 1,2-butanediol, 1,3-butanediol, 1,4-butanediol, 2,3-butanediol, 2,3-dimethyl-2,3-butanediol, neopentyl glycol, pentanediol, hexanediol, heptanediol, octanediol, and 1,6-cyclohexanedimethylol. Aniline diols or bisphenol A diols may be used. Specific examples of triols include glycerin, trimethylol propane, and hexanetriol. Specific examples of tetraols include pentaerythritol and sorbitol.

Examples of high-molecular-weight polyols include polyether polyols such as polyoxyethylene glycol (PEG), polyoxypropylene glycol (PPG), and polytetramethylene ether glycol (PTMG); condensed polyester polyols such as polyethylene adipate (PEA), polybutylene adipate (PBA), and polyhexamethylene adipate (PHMA); lactone polyester polyols such as poly-ε-caprolactone (PCL); polycarbonate polyols such as polyhexamethylene carbonate; and acrylic polyols. Two or more polyols may be used in combination. In light of feel at impact of the golf ball 2, the high-molecular-weight polyol has a number average molecular weight of preferably not less than 400 and more preferably not less than 1000. The number average molecular weight is preferably not greater than 10000.

Examples of polyisocyanates, as a material for the urethane bond, include aromatic diisocyanates, alicyclic diisocyanates, and aliphatic diisocyanates. Two or more types of diisocyanates may be used in combination.

Examples of aromatic diisocyanates include 2,4-toluene diisocyanate, 2,6-toluene diisocyanate, 4,4′-diphenylmethane diisocyanate (MDI), 1,5-naphthylene diisocyanate (NDI), 3,3f-bitolylene-4,4′-diisocyanate (TODI), xylylene diisocyanate (XDI), tetramethylxylylene diisocyanate (TMXDI), and paraphenylene diisocyanate (PPDI). One example of aliphatic diisocyanates is hexamethylene diisocyanate (HDI). Examples of alicyclic diisocyanates include 4,4′-dicyclohexylmethane diisocyanate (H₁₂MDI), 1,3-bis(isocyanatemethyl)cyclohexane (H₆XDI), isophorone diisocyanate (IPDI), and trans-1,4-cyclohexane diisocyanate (CHDI). 4,4′-dicyclohexylmethane diisocyanate is preferable.

Specific examples of the thermoplastic polyurethane include trade names “Elastollan NY80A”, “Elastollan NY82A”, “Elastollan NY83A”, “Elastollan NY84A”, “Elastollan NY85A”, “Elastollan NY88A”, “Elastollan NY90A”, “Elastollan NY95A”, “Elastollan NY97A”, “Elastollan NY585”, and “Elastollan KP016N”, manufactured by BASF Japan Ltd.; and trade names “RESAMINE P4585LS” and “RESAMINE PS62490”, manufactured by Dainichiseika Color & Chemicals Mfg. Co., Ltd.

The resin composition of the outer cover 10 may include a coloring agent, a filler, a dispersant, an antioxidant, an ultraviolet absorber, a light stabilizer, a fluorescent material, a fluorescent brightener, and the like in an adequate amount. When the hue of the golf ball 2 is white, a typical coloring agent is titanium dioxide.

The outer cover 10 preferably has a thickness T3 of not less than 0.30 mm and not greater than 1.00 mm. The golf ball 2 in which the thickness T3 is not less than 0.30 mm has excellent feel at impact and spin performance. From this viewpoint, the thickness T3 is more preferably not less than 0.40 mm and particularly preferably not less than 0.45 mm. The golf ball 2 in which the thickness T3 is not greater than 1.00 mm has excellent resilience performance. From this viewpoint, the thickness T3 is more preferably not greater than 0.80 mm and particularly preferably not greater than 0.60 mm. The thickness is measured at a position immediately below the land 14.

The outer cover 10 preferably has a hardness H3 of not less than 50 and not greater than 80. The golf ball 2 in which the hardness H3 is not less than 50 has excellent resilience performance. From this viewpoint, the hardness H3 is more preferably not less than 53 and particularly preferably not less than 55. The golf ball 2 in which the hardness H3 is not greater than 80 has excellent feel at impact and spin performance. From this viewpoint, the hardness H3 is more preferably not greater than 75 and particularly preferably not greater than 70.

The hardness H3 of the outer cover 10 is measured according to the standards of “ASTM-D 2240-68”. The hardness H3 is measured with a Shore C type hardness scale mounted to an automated hardness meter (trade name “digi test II” manufactured by Heinrich Bareiss Prüfgerätebau GmbH). For the measurement, a sheet that is formed by hot press, is formed from the same material as that of the outer cover 10, and has a thickness of about 2 mm is used. Prior to the measurement, a sheet is kept at 23° C. for two weeks. At the time of measurement, three sheets are stacked.

A product TH3 of the thickness T3 (mm) and the Shore C hardness H3 of the outer cover 10 is preferably not less than 15 and not greater than 70. The golf ball 2 in which the product TH3 is in this range has excellent flight performance and feel at impact. From this viewpoint, the product TH3 is more preferably not less than 20 and not greater than 60, and particularly preferably not less than 25 and not greater than 55.

The golf ball 2 may include a reinforcing layer between the main cover 8 and the outer cover 10. The reinforcing layer firmly adheres to the main cover 8 and also to the outer cover 10. The reinforcing layer suppresses separation of the outer cover 10 from the main cover 8. The reinforcing layer is formed from a resin composition. Examples of a preferable base polymer of the reinforcing layer include two-component curing type epoxy resins and two-component curing type urethane resins. The reinforcing layer preferably has a thickness of not less than 5 μm and not greater than 30 μm.

Preferably, in the golf ball 2, the thickness T2 of the main cover 8 is equal to or larger than the thickness T1 of the inner cover 6. The difference (T2-T1) therebetween is preferably not less than 0.00 mm and not greater than 0.80 mm. The golf ball 2 in which the difference (T2-T1) is in the above range has excellent flight performance and feel at impact. From this viewpoint, the difference (T2−T1) is particularly preferably not less than 0.05 mm and not greater than 0.70 mm.

Preferably, in the golf ball 2, the hardness H2 of the main cover 8 is greater than the hardness H1 of the inner cover 6. The difference (H2−H1) therebetween is preferably not less than 15 and not greater than 55. The golf ball 2 in which the difference (H2−H1) is in the above range has excellent flight performance and feel at impact. From this viewpoint, the difference (H2−H1) is more preferably not less than 20 and not greater than 50, and particularly preferably not less than 25 and not greater than 45.

Preferably, in the golf ball 2, the thickness T2 of the main cover 8 is equal to or larger than the thickness T3 of the outer cover 10. The difference (T2−T3) therebetween is preferably not less than 0.20 mm and not greater than 2.00 mm. The golf ball 2 in which the difference (T2−T3) is in the above range has excellent flight performance and feel at impact. From this viewpoint, the difference (T2−T3) is more preferably not less than 0.25 mm and not greater than 1.50 mm, and particularly preferably not less than 0.30 mm and not greater than 1.20 mm.

Preferably, in the golf ball 2, the hardness H2 of the main cover 8 is greater than the hardness H3 of the outer cover 10. The difference (H2−H3) therebetween is preferably not less than 15 and not greater than 55. The golf ball 2 in which the difference (H2−H3) is in the above range has excellent flight performance and feel at impact. From this viewpoint, the difference (H2−H3) is more preferably not less than 20 and not greater than 50, and particularly preferably not less than 25 and not greater than 45.

The product TH2 of the thickness T2 and the Shore C hardness H2 of the inner cover 6 and the product THs of the value of 5% of the radius of the core 4 and the Shore C hardness Hs at the surface of the core 4 satisfy the following mathematical formula.

15≤(TH2−THs)≤100

In other words, the difference (TH2−THs) is not less than 15 and not greater than 100. The golf ball 2 in which the difference (TH2−THs) is in this range has excellent flight performance and feel at impact. From this viewpoint, the difference (TH2−THs) is more preferably not less than 15 and not greater than 90, and particularly preferably not less than 16 and not greater than 85.

The golf ball 2 satisfies the following mathematical formula.

0.25<((TH1+TH3)/2)/TH2<0.65

In other words, the ratio of the average of the product TH1 in the inner cover 6 and the product TH3 in the outer cover 10 to the product TH2 in the main cover 8 exceeds 0.25 and is less than 0.65. The golf ball 2 in which this ratio is in the above range has excellent flight performance and feel at impact. From this viewpoint, this ratio is more preferably not less than 0.26 and not greater than 0.63, and particularly preferably not less than 0.27 and not greater than 0.60.

The golf ball 2 preferably has an amount of compressive deformation Sb of not less than 2.5 mm and not greater than 4.0 mm. The golf ball 2 having an amount of compressive deformation Sb of not less than 2.5 mm has excellent feel at impact. From this viewpoint, the amount of compressive deformation Sb is preferably not less than 2.8 mm and particularly preferably not less than 3.2 mm. The golf ball 2 having an amount of compressive deformation Sb of not greater than 4.0 mm has excellent flight performance. From this viewpoint, the amount of compressive deformation Sb is more preferably not greater than 3.8 mm and particularly preferably not greater than 3.6 mm.

For measurement of the amount of compressive deformation, a YAMADA type compression tester “SCH” is used. In the tester, the golf ball 2 is placed on a hard plate made of metal. Next, a cylinder made of metal gradually descends toward the golf ball 2. The golf ball 2, squeezed between the bottom face of the cylinder and the hard plate, becomes deformed. A migration distance of the cylinder, starting from the state in which an initial load of 98 N is applied to the golf ball 2 up to the state in which a final load of 1274 N is applied thereto, is measured. A moving speed of the cylinder until the initial load is applied is 0.83 mm/s. A moving speed of the cylinder after the initial load is applied until the final load is applied is 1.67 mm/s.

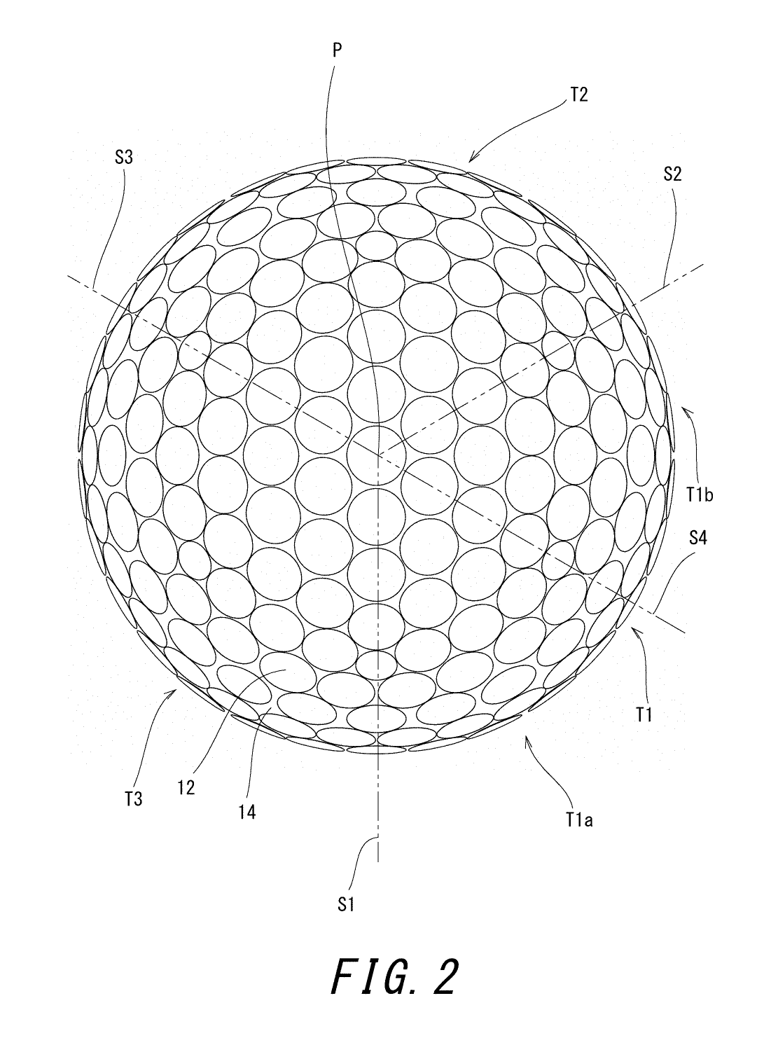

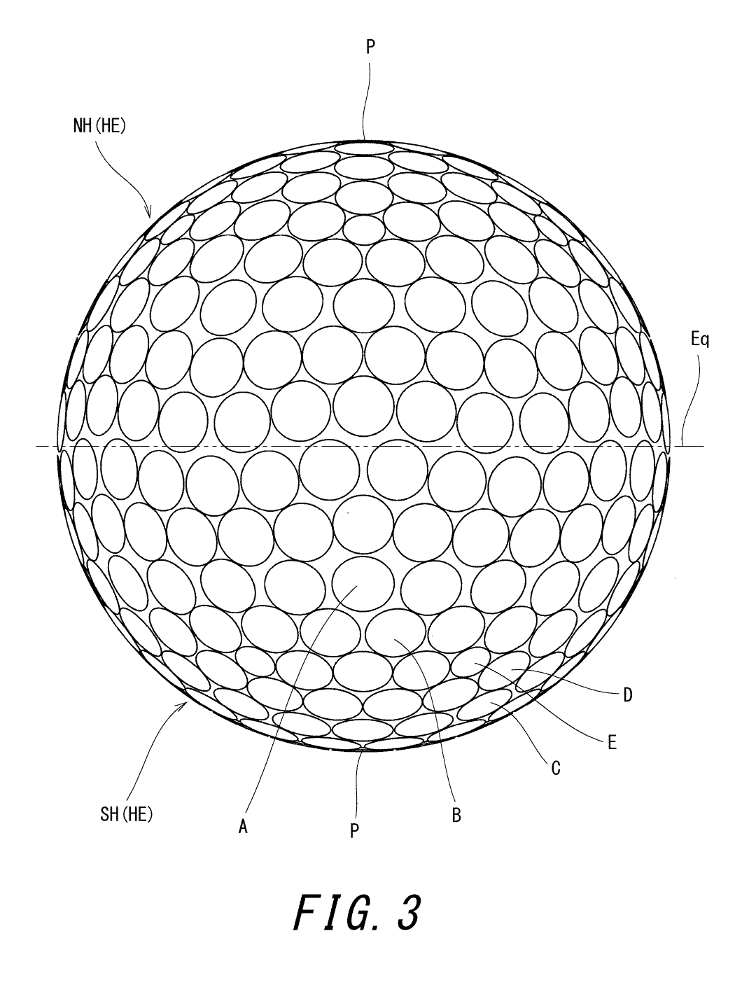

As shown in FIGS. 2 and 3, the golf ball 2 has a large number of dimples 12 on the surface thereof. The contour of each dimple 12 is circular. The golf ball 2 has dimples A each having a diameter of 4.40 mm; dimples B each having a diameter of 4.30 mm; dimples C each having a diameter of 4.20 mm; dimples D each having a diameter of 4.10 mm; and dimples E each having a diameter of 3.00 mm. The number of types of the dimples 12 is five.

The number of the dimples A is 36; the number of the dimples B is 170; the number of the dimples C is 84; the number of the dimples D is 36; and the number of the dimples E is 12. The total number of the dimples 12 is 338. A dimple pattern is formed by these dimples 12 and the land 14.

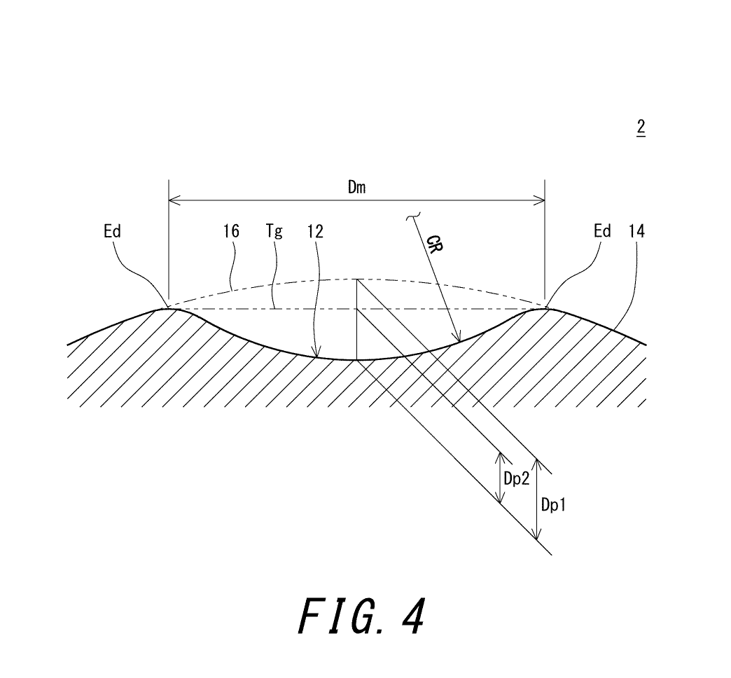

FIG. 4 shows a cross section of the golf ball 2 along a plane passing through the central point of the dimple 12 and the central point of the golf ball 2. In FIG. 4, the top-to-bottom direction is the depth direction of the dimple 12. In FIG. 4, a chain double-dashed line 16 indicates a phantom sphere. The surface of the phantom sphere 16 is the surface of the golf ball 2 when it is postulated that no dimple 12 exists. The diameter of the phantom sphere 16 is equal to the diameter of the golf ball 2. The dimple 12 is recessed from the surface of the phantom sphere 16. The land 14 coincides with the surface of the phantom sphere 16. In the present embodiment, the cross-sectional shape of each dimple 12 is substantially a circular arc. The curvature radius of this circular arc is shown by reference character CR in FIG. 4.

In FIG. 4, an arrow Dm indicates the diameter of the dimple 12. The diameter Dm is the distance between two tangent points Ed appearing on a tangent line Tg that is drawn tangent to the far opposite ends of the dimple 12. Each tangent point Ed is also the edge of the dimple 12. The edge Ed defines the contour of the dimple 12.

The diameter Dm of each dimple 12 is preferably not less than 2.0 mm and not greater than 6.0 mm. The dimple 12 having a diameter Dm of not less than 2.0 mm contributes to turbulization. From this viewpoint, the diameter Dm is more preferably not less than 2.5 mm and particularly preferably not less than 2.8 mm. The dimple 12 having a diameter Dm of not greater than 6.0 mm does not impair a fundamental feature of the golf ball 2 being substantially a sphere. From this viewpoint, the diameter Dm is more preferably not greater than 5.5 mm and particularly preferably not greater than 5.0 mm.

In FIG. 4, a double ended arrow Dp1 indicates a first depth of the dimple 12. The first depth Dp1 is the distance between the deepest part of the dimple 12 and the surface of the phantom sphere 16. In FIG. 4, a double ended arrow Dp2 indicates a second depth of the dimple 12. The second depth Dp2 is the distance between the deepest part of the dimple 12 and the tangent line Tg.

In light of suppression of rising of the golf ball 2 during flight, the first depth Dp1 of each dimple 12 is preferably not less than 0.10 mm, more preferably not less than 0.13 mm, and particularly preferably not less than 0.15 mm. In light of suppression of dropping of the golf ball 2 during flight, the first depth Dp1 is preferably not greater than 0.65 mm, more preferably not greater than 0.60 mm, and particularly preferably not greater than 0.55 mm.

The area S of the dimple 12 is the area of a region surrounded by the contour line of the dimple 12 when the central point of the golf ball 2 is viewed at infinity. In the case of a circular dimple 12, the area S is calculated by the following mathematical formula.

S=(Dm/2)²*π

In the golf ball 2 shown in FIGS. 2 and 3, the area of each dimple A is 15.21 mm²; the area of each dimple B is 14.52 mm²; the area of each dimple C is 13.85 mm²; the area of each dimple D is 13.20 mm²; and the area of each dimple E is 7.07 mm².

In the present invention, the ratio of the sum of the areas S of all the dimples 12 relative to the surface area of the phantom sphere 16 is referred to as an occupation ratio So. From the viewpoint of achieving sufficient turbulization, the occupation ratio So is preferably not less than 78%, more preferably not less than 80%, and particularly preferably not less than 82%. The occupation ratio So is preferably not greater than 95%. In the golf ball 2 shown in FIGS. 2 and 3, the total area of the dimples 12 is 4740.0 mm². The surface area of the phantom sphere 16 of the golf ball 2 is 5728 mm², so that the occupation ratio So is 82.8%.

The standard deviation Su of the areas of all the dimples 12 is preferably not greater than 1.70 mm². The golf ball 2 having a standard deviation Su of not greater than 1.70 mm² has excellent flight performance. From this viewpoint, the standard deviation Su is more preferably not greater than 1.62 mm² and particularly preferably not greater than 1.50 mm². The standard deviation Su is preferably not less than 1.20 mm². In the present embodiment, the average of the areas of all the dimples 12 is 14.02 mm². Therefore, the standard deviation Su of the areas of these dimples is calculated by the following mathematical formula.

$$\begin{matrix}Su = ( ( {( 15.21 - 14.02 )}^{2} * 60 + {( 14.52 - 14.02 )}^{2} * 158 + \\ {( 13.85 - 14.02 )}^{2} * 72 + {( 13.20 - 14.02 )}^{2} * 36 + \\ { {( 7.07 - 14.02 )}^{2} * 12 ) ) \text{/} 338 )}^{1 / 2} \\ = 1.44\end{matrix}$$

From the viewpoint of achieving a sufficient occupation ratio So, the total number of the dimples 12 is preferably not less than 250, more preferably not less than 280, and particularly preferably not less than 300. From the viewpoint that each dimple 12 can contribute to turbulization, the total number is preferably not greater than 450, more preferably not greater than 410, and particularly preferably not greater than 390.

In the present invention, the “volume V of the dimple” means the volume of a portion surrounded by the surface of the phantom sphere 16 and the surface of the dimple 12. The total volume TV of the dimples 12 is preferably not less than 450 mm³ and not greater than 750 mm³. With the golf ball 2 having a total volume TV of not less than 450 mm³, rising of the golf ball 2 during flight is suppressed. From this viewpoint, the total volume TV is more preferably not less than 480 mm³ and particularly preferably not less than 500 mm³. With the golf ball 2 having a total volume TV of not greater than 750 mm³, dropping of the golf ball 2 during flight is suppressed. From this viewpoint, the total volume TV is more preferably not greater than 730 mm³ and particularly preferably not greater than 710 mm³.

As shown in FIG. 3, the surface of the golf ball 2 (or the phantom sphere 16) can be divided into two hemispheres HE by an equator Eq. Specifically, the surface can be divided into a northern hemisphere NH and a southern hemisphere SH. Each hemisphere HE has a pole P. The pole P corresponds to a deepest point of a mold for the golf ball 2.

The plan view in FIG. 2 shows the northern hemisphere. The southern hemisphere (corresponding to a bottom view) has a pattern obtained by rotating the dimple pattern in FIG. 2 about the pole P. Line segments S1, S2, and S3 shown in FIG. 2 each extend from the pole P. The angle at the pole P between the line segment S1 and the line segment S2 is 120°. The angle at the pole P between the line segment S2 and the line segment S3 is 120°. The angle at the pole P between the line segment S3 and the line segment S1 is 120°.

Of the surface of the golf ball 2 (or the phantom sphere 16), a zone surrounded by the line segment S1, the line segment S2, and the equator Eq (see FIG. 3) is a first spherical triangle T1. Of the surface of the golf ball 2 (or the phantom sphere 16), a zone surrounded by the line segment S2, the line segment S3, and the equator Eq is a second spherical triangle T2. Of the surface of the golf ball 2 (or the phantom sphere 16), a zone surrounded by the line segment S3, the line segment S1, and the equator Eq is a third spherical triangle T3. Each spherical triangle is a unit. The hemisphere HE can be divided into the three units.

When the dimple pattern of the first spherical triangle T1 is rotated by 120° about a straight line connecting the two poles P, the resultant dimple pattern substantially overlaps the dimple pattern of the second spherical triangle T2. When the dimple pattern of the second spherical triangle T2 is rotated by 120° about the straight line connecting the two poles P, the resultant dimple pattern substantially overlaps the dimple pattern of the third spherical triangle T3. When the dimple pattern of the third spherical triangle T3 is rotated by 120° about the straight line connecting the two poles P, the resultant dimple pattern substantially overlaps the dimple pattern of the first spherical triangle T1. In other words, the dimple pattern of the hemisphere is composed of three units that are rotationally symmetrical to each other.

A pattern obtained by rotating the dimple pattern of each hemisphere HE by 120° about the straight line connecting the two poles P substantially overlaps the dimple pattern that has not been rotated. The dimple pattern of each hemisphere HE has 120° rotational symmetry.

A line segment S4 shown in FIG. 2 extends from the pole P. The angle at the pole P between the line segment S4 and the line segment S1 is 60°. The angle at the pole P between the line segment S4 and the line segment S2 is 60°. The first spherical triangle T1 (unit) can be divided into a small spherical triangle T1a and another small spherical triangle T1b by the line segment S4. The spherical triangle T1a and the spherical triangle T1b are small units.

A pattern obtained by inverting the dimple pattern of the spherical triangle T1a with respect to a plane containing the line segment S4 and the straight line connecting both poles P substantially overlaps the dimple pattern of the spherical triangle T1b. In other words, the dimple pattern of the first spherical triangle T1 (unit) is composed of two small units that are mirror-symmetrical to each other.

Although not shown, similar to the first spherical triangle T1, the dimple pattern of the second spherical triangle T2 is also composed of two small units that are mirror-symmetrical to each other. The dimple pattern of the third spherical triangle T3 is also composed of two small units that are mirror-symmetrical to each other. The dimple pattern of the hemisphere HE is composed of the six small units.

According to the findings by the present inventor, with the golf ball 2 of which the dimple pattern of each hemisphere is composed of three units that are rotationally symmetrical to each other and the dimple pattern of each unit is composed of two small units that are mirror-symmetrical to each other, turbulization is promoted. The golf ball 2 has excellent flight performance.

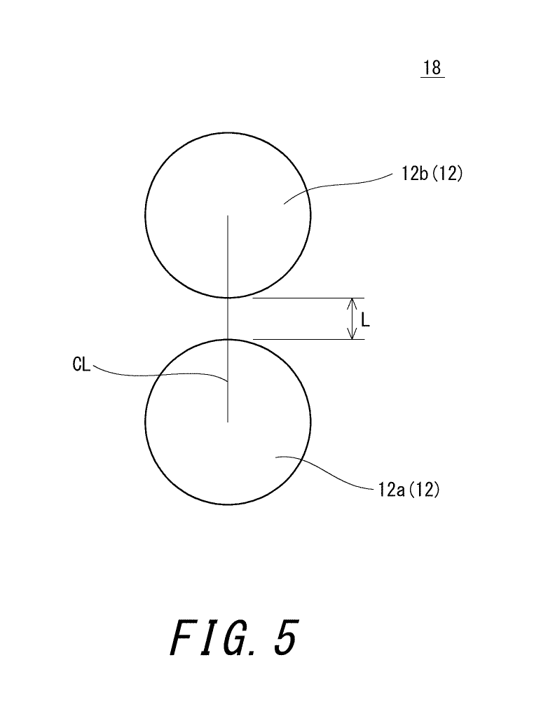

FIG. 5 is a partially enlarged view of the golf ball 2 in FIG. 2. FIG. 5 shows a first dimple 12a and a second dimple 12b. For the first dimple 12a, the second dimple 12b is a neighboring dimple. For the second dimple 12b, the first dimple 12a is a neighboring dimple. The first dimple 12a and the second dimple 12b form one neighboring dimple pair 18.

In FIG. 5, reference character CL represents the line segment that connects the center of the first dimple 12a and the center of the second dimple 12b to each other. In FIG. 5, reference character L represents the distance between the dimples 12 of the neighboring dimple pair 18. The distance L is measured along the line segment CL.

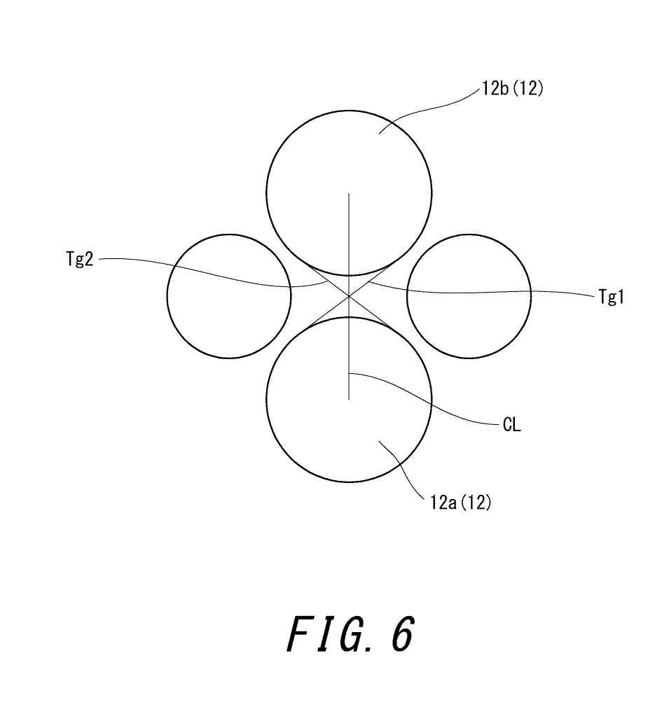

The surface of the golf ball 2 is a curved surface. The size of each dimple 12 is sufficiently small as compared to the size of the golf ball 2. Thus, in FIG. 5, the curved surface is approximated to a plane, the line segment CL is drawn, and the distance L is measured. Also in FIGS. 6 to 9 described below, similarly, the curved surface is approximated to a plane.

The following will describe the definition of neighboring dimples. FIG. 6 shows a first dimple 12a and a second dimple 12b. The line segment CL that connects the center of the first dimple 12a and the center of the second dimple 12b to each other does not intersect any dimple 12 other than the first dimple 12a and the second dimple 12b.

In FIG. 6, reference character Tg1 represents a first common inscribed line of the first dimple 12a and the second dimple 12b. The first common inscribed line Tg1 has an end on the circumference of the first dimple 12a, and another end on the circumference of the second dimple 12b. The first common inscribed line Tg1 does not intersect any dimple 12.

In FIG. 6, reference character Tg2 represents a second common inscribed line of the first dimple 12a and the second dimple 12b. The second common inscribed line Tg2 has an end on the circumference of the first dimple 12a, and another end on the circumference of the second dimple 12b. The second common inscribed line Tg2 does not intersect any dimple 12.

In the present invention, when two dimples 12 satisfy both of conditions (1) and (2) described below, these dimples 12 are referred to as a “neighboring dimple pair”.

(1) The straight line that connects the centers of these dimples 12 to each other does not intersect any other dimple 12.

(2) Each of the two common inscribed lines of these dimples 12 does not intersect any dimple 12.

When a neighboring dimple pair 18 is present, one dimple 12 of the neighboring dimple pair 18 is a neighboring dimple with respect to the other dimple 12, and the other dimple 12 is a neighboring dimple with respect to the one dimple 12.

The first dimple 12a and the second dimple 12b shown in FIG. 6 form a neighboring dimple pair 18. The first dimple 12a is a neighboring dimple with respect to the second dimple 12b, and the second dimple 12b is a neighboring dimple with respect to the first dimple 12a.

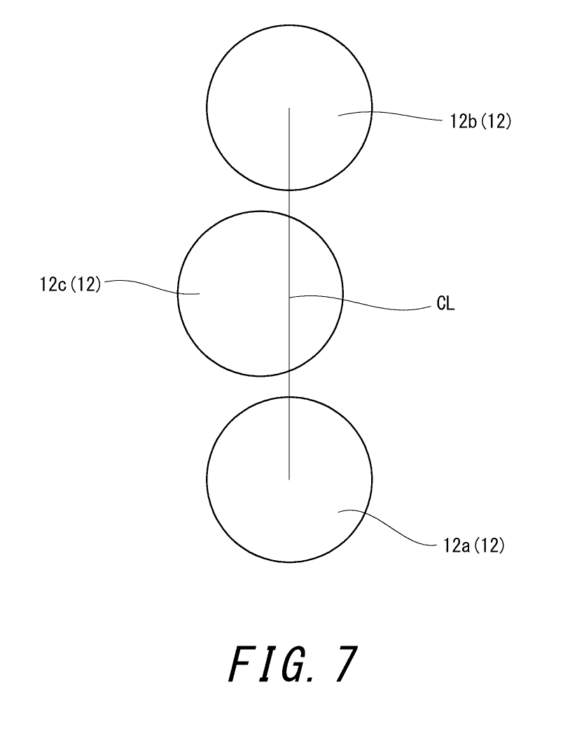

FIG. 7 shows a first dimple 12a, a second dimple 12b, and a third dimple 12c. The line segment CL that connects the center of the first dimple 12a and the center of the second dimple 12b to each other intersects the third dimple 12c. Therefore, a pair of the first dimple 12a and the second dimple 12b is not a neighboring dimple pair 18. The first dimple 12a is not a neighboring dimple with respect to the second dimple 12b, and the second dimple 12b is not a neighboring dimple with respect to the first dimple 12a.

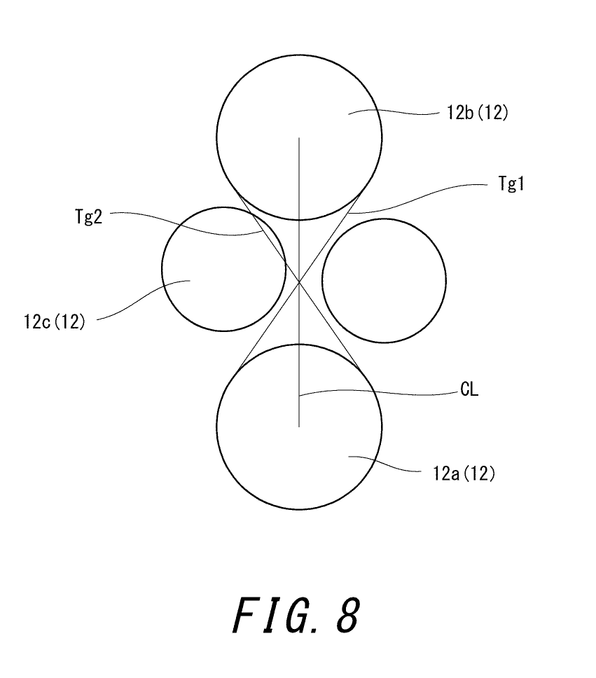

FIG. 8 shows a first dimple 12a, a second dimple 12b, and a third dimple 12c. The line segment CL that connects the center of the first dimple 12a and the center of the second dimple 12b to each other does not intersect any dimple 12 other than the first dimple 12a and the second dimple 12b. The first common inscribed line Tg1 does not intersect any dimple 12. However, the second common inscribed line Tg2 intersects the third dimple 12c. Therefore, a pair of the first dimple 12a and the second dimple 12b is not a neighboring dimple pair 18. The first dimple 12a is not a neighboring dimple with respect to the second dimple 12b, and the second dimple 12b is not a neighboring dimple with respect to the first dimple 12a.

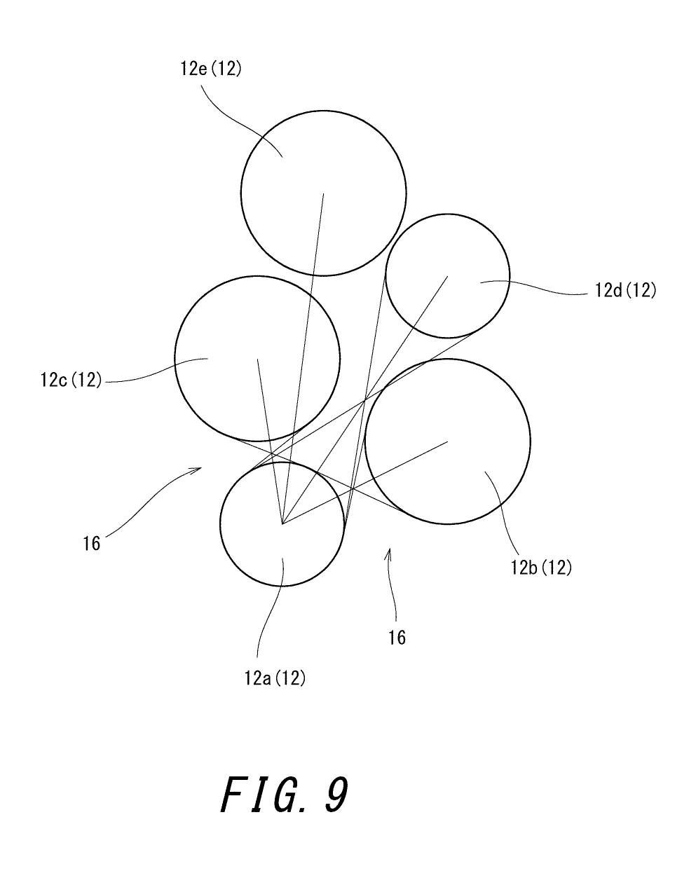

FIG. 9 shows a first dimple 12a, a second dimple 12b, a third dimple 12c, a fourth dimple 12d, and a fifth dimple 12e.

The line segment that connects the center of the first dimple 12a and the center of the second dimple 12b to each other does not intersect any dimple 12 other than the first dimple 12a and the second dimple 12b. Furthermore, each of the two common inscribed lines of the first dimple 12a and the second dimple 12b does not intersect any dimple 12. The first dimple 12a and the second dimple 12b form a neighboring dimple pair 18.

The line segment that connects the center of the first dimple 12a and the center of the third dimple 12c to each other does not intersect any dimple 12 other than the first dimple 12a and the third dimple 12c. Furthermore, each of the two common inscribed lines of the first dimple 12a and the third dimple 12c does not intersect any dimple 12. The first dimple 12a and the third dimple 12c form a neighboring dimple pair 18.

One of the two common inscribed lines of the first dimple 12a and the fourth dimple 12d intersects the second dimple 12b. Therefore, the first dimple 12a and the fourth dimple 12d do not form a neighboring dimple pair 18.

The line segment that connects the center of the first dimple 12a and the center of the fifth dimple 12e to each other intersects the third dimple 12c. Therefore, the first dimple 12a and the fifth dimple 12e do not form a neighboring dimple pair 18.

As described above, the first dimple 12a and the second dimple 12b form a neighboring dimple pair 18, and the first dimple 12a and the third dimple 12c also form a neighboring dimple pair 18. In FIG. 9, at least two neighboring dimple pairs 18 are present.

As described above, for the first dimple 12a, the second dimple 12b is a neighboring dimple, and the third dimple 12c is also a neighboring dimple. For the first dimple 12a, at least two neighboring dimples are present. Therefore, the first dimple 12a has at least two distances L (see FIG. 5). For the first dimple 12a, still another neighboring dimple may be present. In the entire golf ball 2, for each dimple 12, a neighboring dimple can be present. In the golf ball 2, a large number of neighboring dimple pairs 18 are present.

The standard deviation Pd of the distances L between the dimples 12 of all the neighboring dimple pairs 18 is preferably less than 0.500 mm. In other words, the standard deviation Pd is preferably small. As described above, in the golf ball 2, the standard deviation Su of the areas of the dimples 12 is small. In the golf ball 2 having a small standard deviation Su and a small standard deviation Pd, the dimples 12, the sizes of which are less varied, are uniformly arranged.

The vector of the lift force applied to the golf ball 2 on a trajectory after the peak has an upward vertical component and a forward horizontal component. The upward vertical component delays drop of the golf ball 2. In other words, the upward vertical component contributes to long flight duration. The forward horizontal component carries the golf ball 2 forward. With the golf ball 2 to which the lift force on a trajectory after the peak is large, a large flight distance is achieved.

According to the findings by the present inventor, with the golf ball 2 having a small standard deviation Su and a small standard deviation Pd, the lift force on a trajectory after the peak is large. The golf ball 2 has excellent flight performance. In light of flight performance, the standard deviation Pd is more preferably not greater than 0.458 mm, further preferably not greater than 0.400 mm, and particularly preferably not greater than 0.317 mm.

The average of the distances L between the dimples 12 of all the neighboring dimple pairs 18 is preferably not greater than 1.0 mm, more preferably not greater than 0.7 mm, and particularly preferably not greater than 0.5 mm. The average is preferably not less than 0.0 mm.

### EXAMPLES

### Example 1

A rubber composition I was obtained by kneading 100 parts by weight of a high-cis polybutadiene (trade name “BR-730”, manufactured by JSR Corporation), 28.5 parts by weight of zinc diacrylate, 12 parts by weight of zinc oxide, an appropriate amount of barium sulfate, 0.5 parts by weight of diphenyl disulfide, 0.9 parts by weight of dicumyl peroxide, and 2 parts by weight of benzoic acid. This rubber composition I was placed into a mold including upper and lower mold halves each having a hemispherical cavity, and heated at 170° C. for 18 minutes to obtain a core with a diameter of 37.80 mm. The amount of barium sulfate was adjusted such that a core having a predetermined weight was obtained.

A resin composition b was obtained by kneading 26 parts by weight of an ionomer resin (the aforementioned “Himilan AM7337”), 26 parts by weight of another ionomer resin (the aforementioned “Himilan AM7329”), 48 parts by weight of a styrene block-containing thermoplastic elastomer (the aforementioned “Rabalon T3221C”), 4 parts by weight of titanium dioxide, and 0.2 parts by weight of a light stabilizer (trade name “JF-90”, manufactured by Johoku Chemical Co., Ltd.) with a twin-screw kneading extruder. The core was placed into a mold including upper and lower mold halves each having a hemispherical cavity. The core was covered with the resin composition b by injection molding to form an inner cover. The thickness of the inner cover was 0.950 mm.

A resin composition f was obtained by kneading 55 parts by weight of an ionomer resin (the aforementioned “Himilan AM7329”), 45 parts by weight of another ionomer resin (the aforementioned “Himilan 1555”), 4 parts by weight of titanium dioxide, and 0.2 parts by weight of a light stabilizer (the aforementioned “JF-90”) with a twin-screw kneading extruder. The sphere consisting of the core and the inner cover was placed into a mold including upper and lower mold halves each having a hemispherical cavity. The sphere was covered with the resin composition f by injection molding to form a main cover. The thickness of the main cover was 1.00 mm.

A paint composition (trade name “POLIN 750LE”, manufactured by SHINTO PAINT CO., LTD.) including a two-component curing type epoxy resin as a base polymer was prepared. The base material liquid of this paint composition includes 30 parts by weight of a bisphenol A type epoxy resin and 70 parts by weight of a solvent. The curing agent liquid of this paint composition includes 40 parts by weight of a modified polyamide amine, 55 parts by weight of a solvent, and 5 parts by weight of titanium dioxide. The weight ratio of the base material liquid to the curing agent liquid is 1/1. This paint composition was applied to the surface of the main cover with a spray gun, and kept at 23° C. for 12 hours to obtain a reinforcing layer with a thickness of 10 μm.

A resin composition j was obtained by kneading 30 parts by weight of a thermoplastic polyurethane elastomer (the aforementioned “Elastollan NY85A”), 70 parts by weight of another thermoplastic polyurethane elastomer (the aforementioned “Elastollan NY88A”), 0.2 parts by weight of a light stabilizer (trade name “TINUVIN 770”), 4 parts by weight of titanium dioxide, and 0.04 parts by weight of ultramarine blue with a twin-screw kneading extruder. Half shells were obtained from the resin composition j by compression molding. The sphere consisting of the core, the inner cover, and the main cover was covered with two of these half shells. These half shells and the sphere were placed into a final mold that includes upper and lower mold halves each having a hemispherical cavity and having a large number of pimples on its cavity face, and an outer cover was obtained by compression molding. The thickness of the outer cover was 0.50 mm. Dimples having a shape that is the inverted shape of the pimples were formed on the outer cover.

A clear paint including a two-component curing type polyurethane as a base material was applied to this outer cover to obtain a golf ball of Example 1 with a diameter of about 42.7 mm and a weight of about 45.6 g. Dimple specifications Dl of the golf ball are shown in detail in Tables 5 and 7 below. FIG. 2 is a plan view of the golf ball, and FIG. 3 is a front view of the golf ball.

### Examples 2 to 5 and Comparative Examples 1 and 2

Golf balls of Examples 2 to 5 and Comparative Examples 1 and 2 were obtained in the same manner as Example 1, except the specifications of the dimples were as shown in Tables 9 and 10 below. The specifications of the dimples are shown in detail in Tables 5 to 8 below.

### Examples 6 to 9 and Comparative Examples 3 to 8

Golf balls of Examples 6 to 9 and Comparative Examples 3 to 8 were obtained in the same manner as Example 1, except the specifications of the core, the inner cover, the main cover, the outer cover, and the dimples were as shown in Tables 11 and 12 below. The composition of the core is shown in detail in Table 1 below. The composition of the inner cover is shown in detail in Table 2 below. The composition of the main cover is shown in detail in Table 3 below. The composition of the outer cover is shown in detail in Table 4 below. The specifications of the dimples are shown in detail in Tables 5 to 8 below.

[Flight Test]

A driver with a head made of a titanium alloy (trade name “XXIO 9”, manufactured by DUNLOP SPORTS CO. LTD., shaft hardness: R, loft angle: 10.5°) was attached to a swing machine manufactured by Golf Laboratories, Inc. A golf ball was hit under a condition of a head speed of 40 m/sec, and the ball speed and the spin rate immediately after the hit, and the flight distance, were measured. The flight distance is the distance from the launch point to the stop point. During the test, the weather was almost windless. The average value of data obtained by 12 measurements is shown in Tables 9 to 12 below.

TABLE 1
Composition of Core (parts by weight)

| | I | II |
|---|---|---|
| Polybutadiene | 100 | 100 |
| Zinc diacrylate | 28.5 | 24.0 |
| Zinc oxide | 12 | 5 |
| Barium sulfate | A.A. | A.A. |
| Diphenyl disulfide | 0.5 | 0.5 |
| Pentabromophenyl disulfide | — | 0.3 |
| Dicumyl peroxide | 0.9 | 0.9 |
| Benzoic acid | 2 | — |
| Crosslinking temperature (° C.) | 165 | 165 |
| Crosslinking time (min) | 20 | 20 |

A.A.: Appropriate amount

TABLE 2
Composition of Inner Cover (parts by weight

| | a | b | c | d |
|---|---|---|---|---|
| Himilan AM7337 | 22 | 26 | 30 | 38.5 |
| Himilan AM7329 | 22 | 26 | 30 | 38.5 |
| Rabalon T3221C | 56 | 48 | 40 | 23 |
| Titanium dioxide | 4 | 4 | 4 | 4 |
| JF-90 | 0.2 | 0.2 | 0.2 | 0.2 |
| Hardness H1 | 50 | 57 | 63 | 76 |
| (Shore C) | | | | |

TABLE 3
Composition of Main Cover (parts by weight)

| | e | f | g | h |
|---|---|---|---|---|
| Himilan AM7329 | 45 | 55 | 50 | 50 |
| Himilan 1605 | — | — | 50 | 25 |
| Himilan 1555 | 50 | 45 | — | — |
| Surlyn 8150 | — | — | — | 25 |
| Rabalon T3221C | 5 | — | — | — |
| Titanium dioxide | 4 | 4 | 4 | 4 |
| JF-90 | 0.2 | 0.2 | 0.2 | 0.2 |
| Hardness H2 | 88 | 92 | 96 | 100 |
| (Shore C) | | | | |

TABLE 4
Composition of Outer Cover (parts by weight)

| | i | j | k | l |
|---|---|---|---|---|
| Elastollan NY83A | 100 | — | — | — |
| Elastollan NY85A | — | 30 | — | — |
| Elastollan NY88A | — | 70 | — | — |
| Elastollan NY90A | — | — | 90 | 25 |
| Elastollan NY97A | — | — | 10 | 75 |
| TINUVIN 770 | 0.2 | 0.2 | 0.2 | 0.2 |
| Titanium dioxide | 4 | 4 | 4 | 4 |
| Ultramarine blue | 0.04 | 0.04 | 0.04 | 0.04 |
| Hardness H3 | 50 | 57 | 63 | 70 |
| (Shore C) | | | | |

TABLE 5
Specifications of Dimples

| | | | Dm | Dp2 | Dp1 | CR | S | V |
|---|---|---|---|---|---|---|---|---|
| | | Number | (mm) | (mm) | (mm) | (mm) | (mm²) | (mm³) |
| D1 | A | 36 | 4.40 | 0.135 | 0.2487 | 17.99 | 15.21 | 1.892 |
| | B | 170 | 4.30 | 0.135 | 0.2435 | 17.19 | 14.52 | 1.770 |
| | D | 84 | 4.20 | 0.135 | 0.2385 | 16.40 | 13.85 | 1.654 |
| | E | 36 | 4.10 | 0.135 | 0.2336 | 15.63 | 13.20 | 1.544 |
| | F | 12 | 3.00 | 0.135 | 0.1878 | 8.40 | 7.07 | 0.665 |
| D2 | A | 60 | 4.40 | 0.138 | 0.2517 | 17.61 | 15.21 | 1.915 |
| | B | 158 | 4.30 | 0.137 | 0.2455 | 16.94 | 14.52 | 1.785 |
| | C | 72 | 4.15 | 0.134 | 0.2351 | 16.13 | 13.53 | 1.592 |
| | D | 36 | 3.90 | 0.123 | 0.2122 | 15.52 | 11.95 | 1.269 |
| | E | 12 | 3.00 | 0.122 | 0.1748 | 9.28 | 7.07 | 0.619 |
| D3 | A | 314 | 4.20 | 0.135 | 0.2385 | 16.40 | 13.85 | 1.654 |
| | B | 12 | 3.90 | 0.135 | 0.2242 | 14.15 | 11.95 | 1.341 |
| | C | 12 | 3.00 | 0.135 | 0.1878 | 8.40 | 7.07 | 0.665 |
| D4 | A | 102 | 4.50 | 0.135 | 0.2539 | 18.82 | 15.90 | 2.021 |
| | B | 24 | 4.40 | 0.135 | 0.2487 | 17.99 | 15.21 | 1.892 |
| | C | 30 | 4.30 | 0.135 | 0.2435 | 17.19 | 14.52 | 1.770 |
| | D | 54 | 4.20 | 0.135 | 0.2385 | 16.40 | 13.85 | 1.654 |
| | E | 108 | 4.00 | 0.135 | 0.2289 | 14.88 | 12.57 | 1.440 |
| | F | 12 | 3.50 | 0.135 | 0.2068 | 11.41 | 9.62 | 0.997 |

TABLE 6
Specifications of Dimples

| | | | Dm | Dp2 | Dp1 | CR | S | V |
|---|---|---|---|---|---|---|---|---|
| | | Number | (mm) | (mm) | (mm) | (mm) | (mm²) | (mm³) |
| D5 | A | 338 | 4.11 | 0.120 | 0.2189 | 17.61 | 13.23 | 1.450 |
| D6 | A | 30 | 4.60 | 0.125 | 0.2492 | 21.22 | 16.62 | 2.073 |
| | B | 54 | 4.50 | 0.125 | 0.2439 | 20.31 | 15.90 | 1.941 |
| | C | 72 | 4.30 | 0.125 | 0.2335 | 18.55 | 14.52 | 1.697 |
| | D | 54 | 4.20 | 0.125 | 0.2285 | 17.70 | 13.85 | 1.585 |
| | E | 108 | 4.00 | 0.125 | 0.2189 | 16.06 | 12.57 | 1.377 |
| | F | 12 | 2.70 | 0.125 | 0.1677 | 7.35 | 5.73 | 0.481 |
| D7 | A | 16 | 4.60 | 0.135 | 0.2592 | 19.66 | 16.62 | 2.157 |
| | B | 30 | 4.50 | 0.135 | 0.2539 | 18.82 | 15.90 | 2.021 |
| | C | 30 | 4.40 | 0.135 | 0.2487 | 17.99 | 15.21 | 1.892 |
| | D | 150 | 4.30 | 0.135 | 0.2435 | 17.19 | 14.52 | 1.770 |
| | E | 30 | 4.20 | 0.135 | 0.2385 | 16.40 | 13.85 | 1.654 |
| | F | 66 | 4.10 | 0.135 | 0.2336 | 15.63 | 13.20 | 1.544 |
| | G | 10 | 3.80 | 0.135 | 0.2197 | 13.44 | 11.34 | 1.247 |
| | H | 12 | 3.40 | 0.135 | 0.2028 | 10.77 | 9.08 | 0.922 |

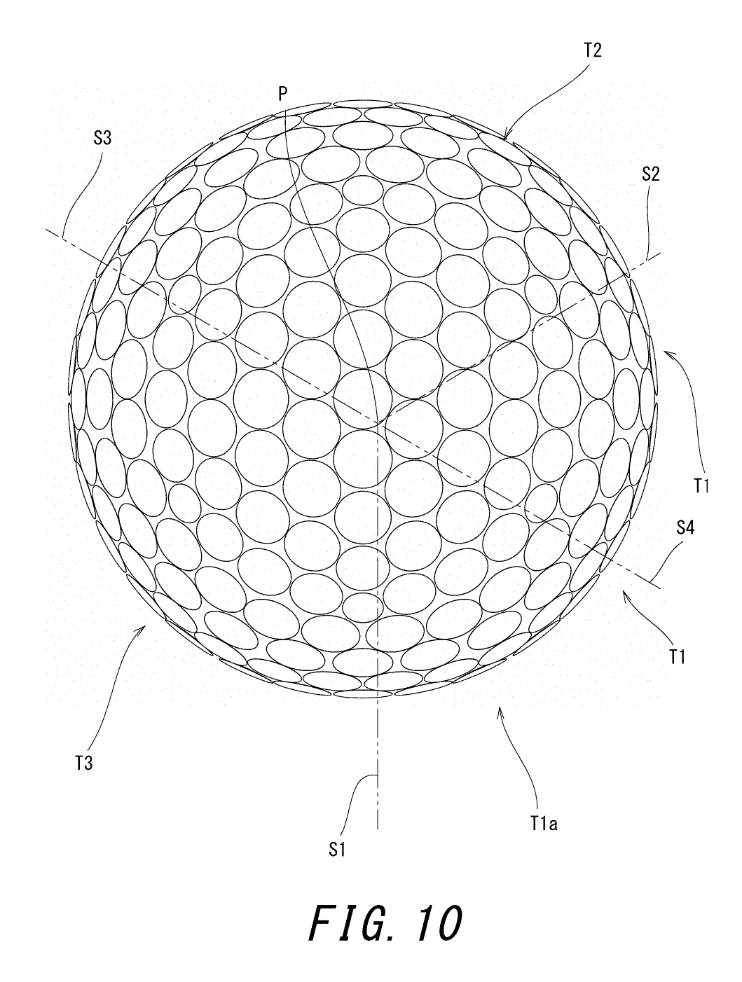

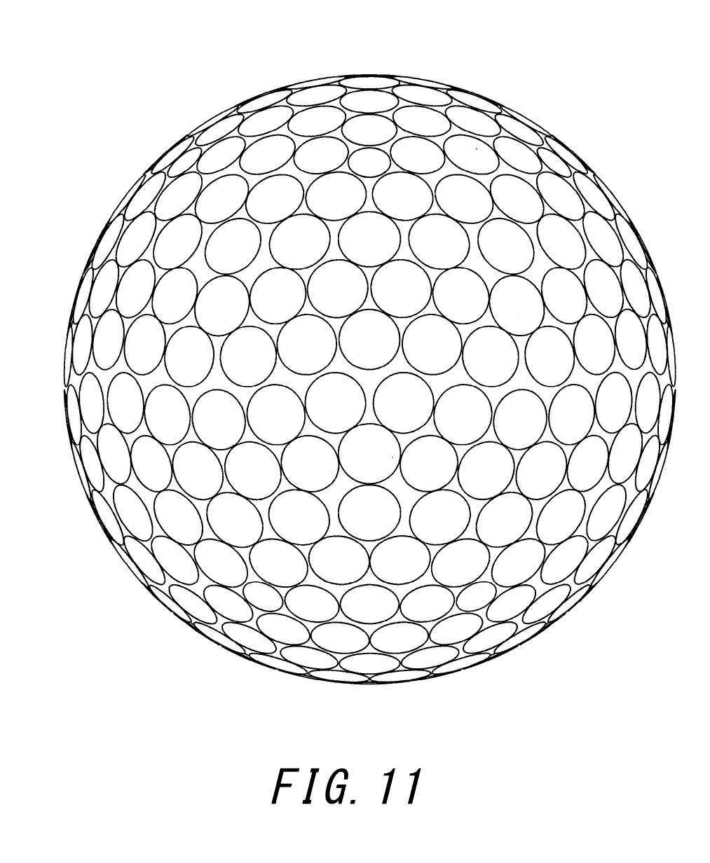

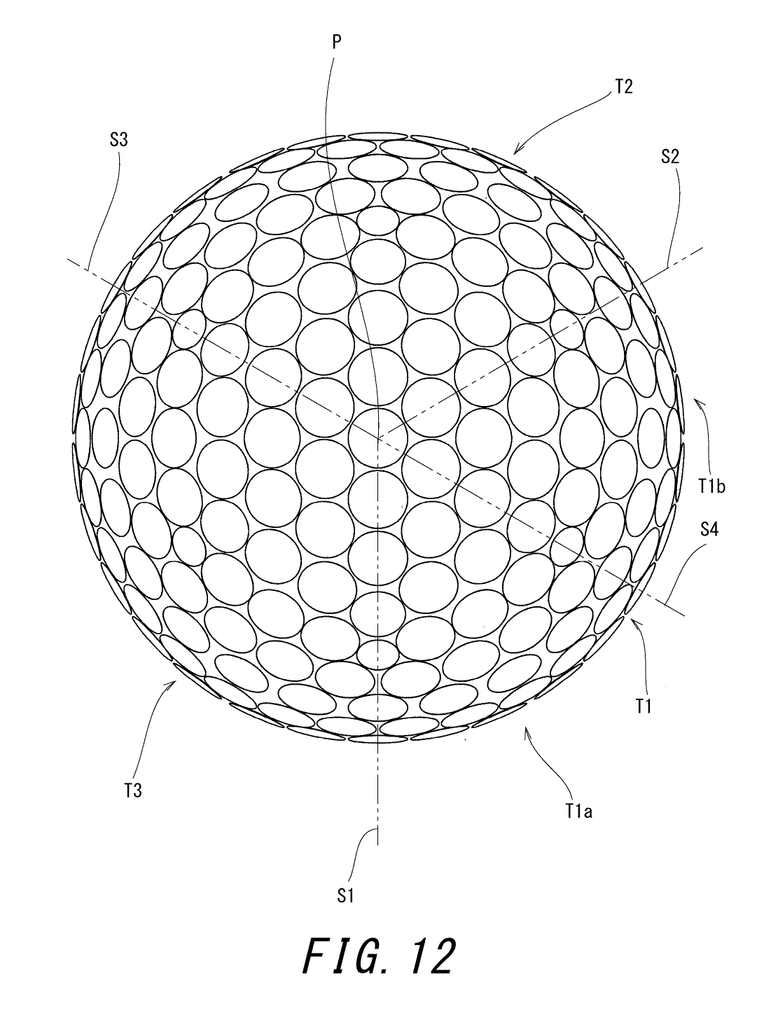

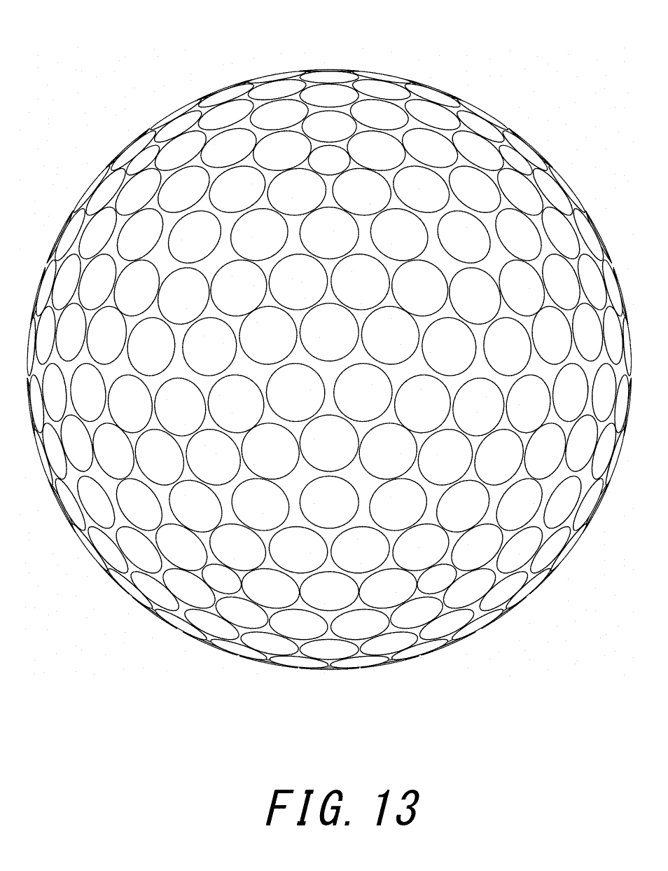

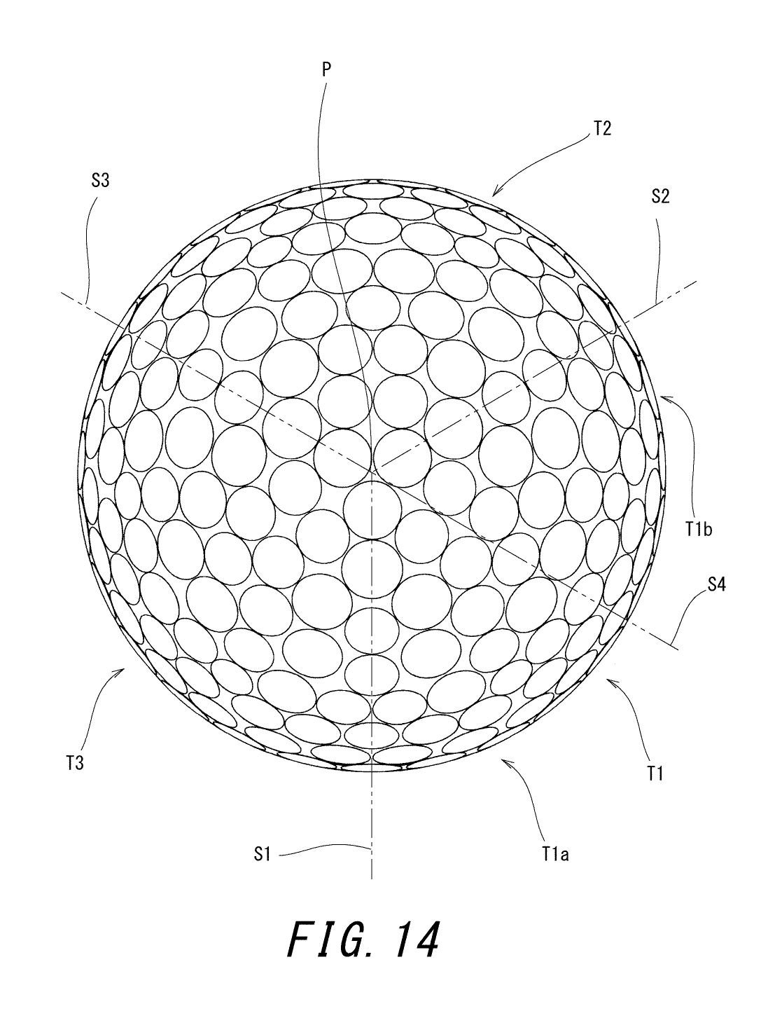

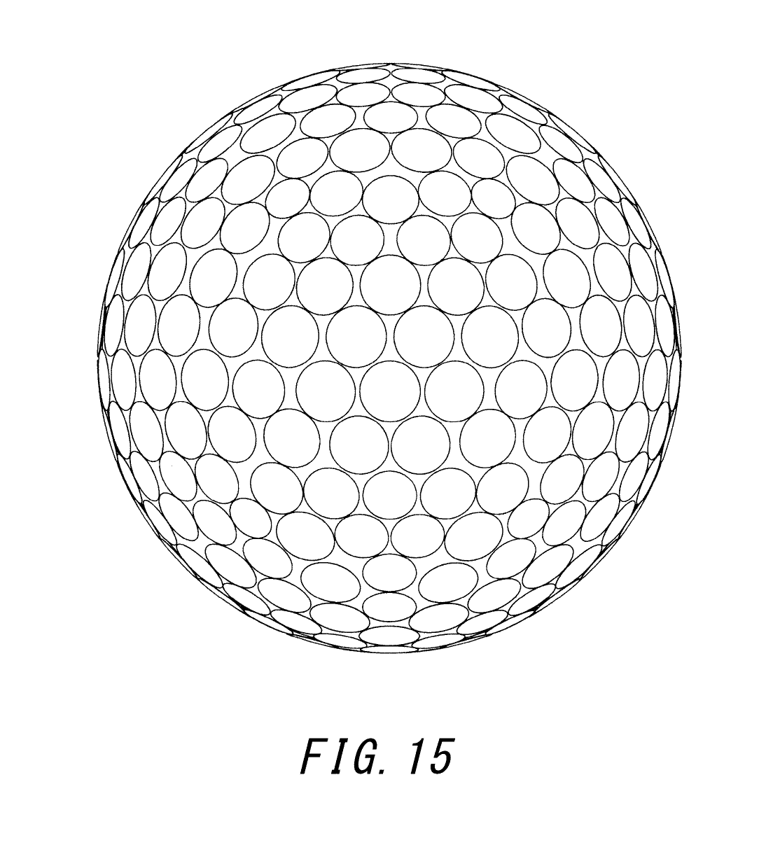

TABLE 7
Specifications of Dimples

| | D1 | D2 | D3 | D4 |
|---|---|---|---|---|
| Plan view | FIG. 2 | FIG. 10 | FIG. 12 | FIG. 14 |
| Front view | FIG. 3 | FIG. 11 | FIG. 13 | FIG. 15 |
| Number of dimples | 338 | 338 | 338 | 330 |
| Number of units | 3 | 3 | 3 | 3 |
| Number of small | 6 | 6 | 6 | 6 |
| units | | | | |
| Occupation ratio | 82.8 | 82.0 | 79.9 | 81.1 |
| So (%) | | | | |
| Total volume TV | 571.6 | 564.6 | 543.5 | 561.5 |
| (mm³) | | | | |
| Standard | 1.44 | 1.61 | 1.29 | 1.62 |
| deviation Su of S | | | | |
| (mm²) | | | | |
| Number of | 1,068 | 1,068 | 1,068 | 1,014 |
| neighboring | | | | |
| dimple pairs | | | | |
| Average of L | 0.280 | 0.295 | 0.345 | 0.332 |
| (mm) | | | | |
| Standard | 0.314 | 0.302 | 0.317 | 0.458 |
| deviation Pd of L | | | | |
| (mm) | | | | |

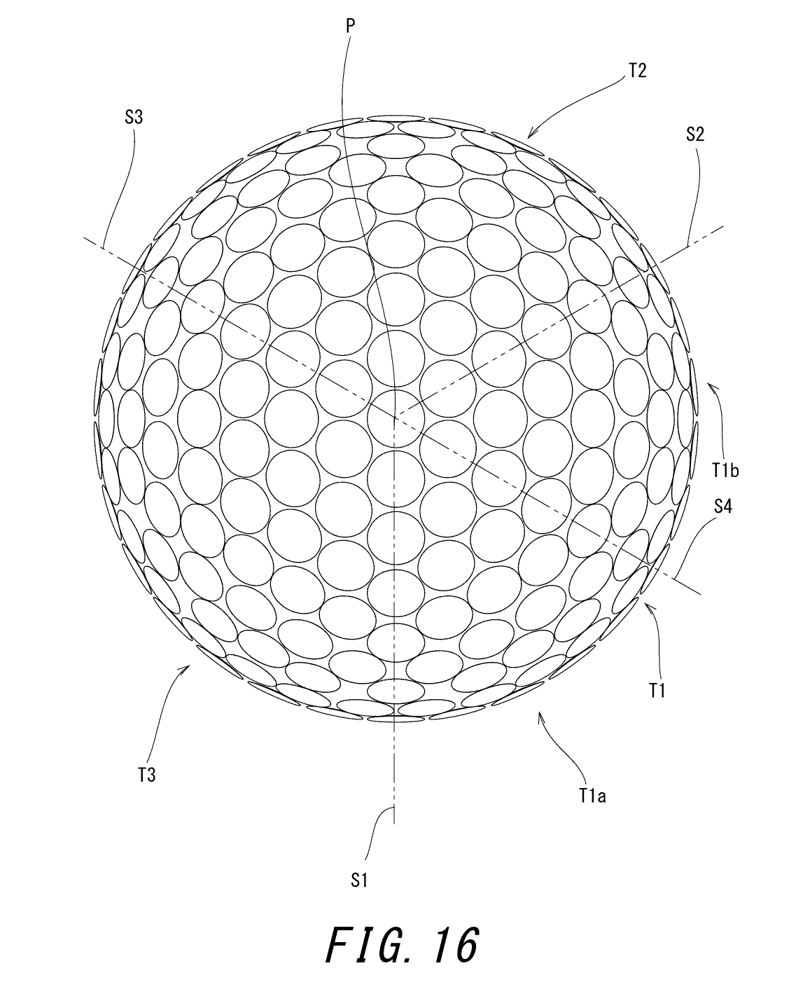

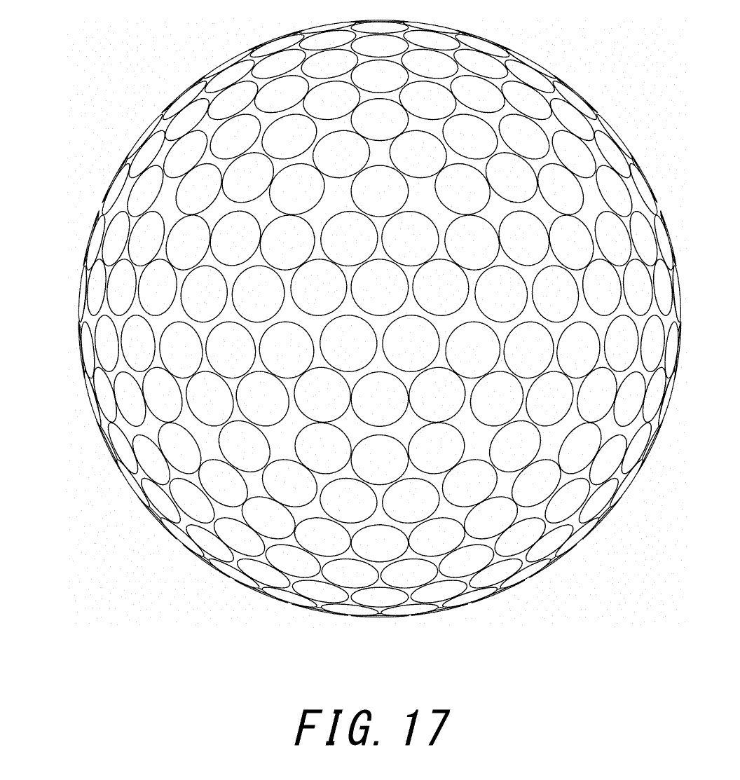

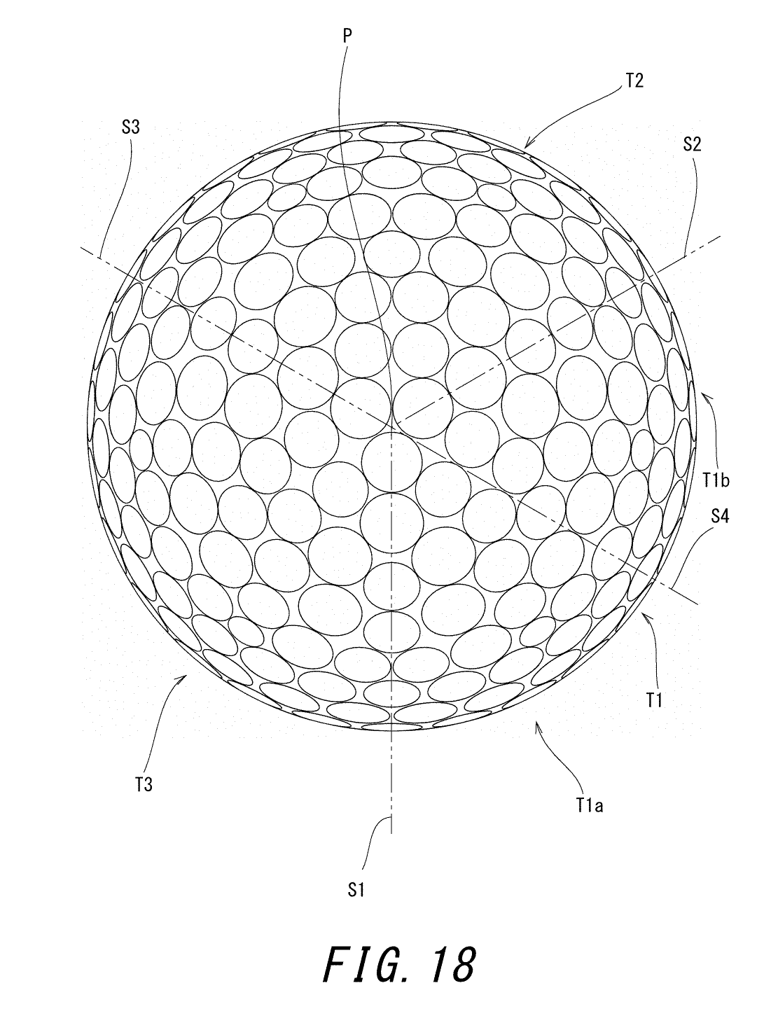

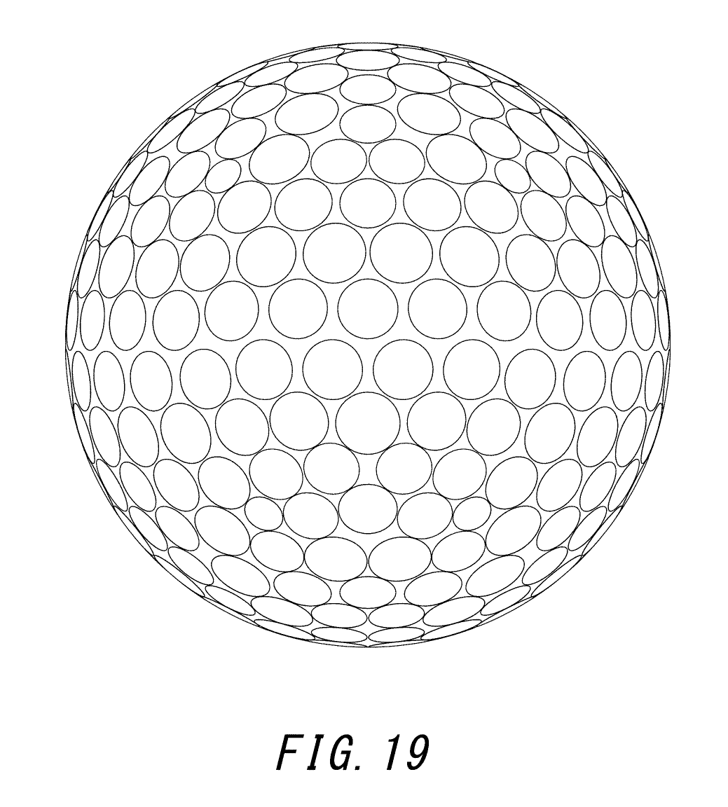

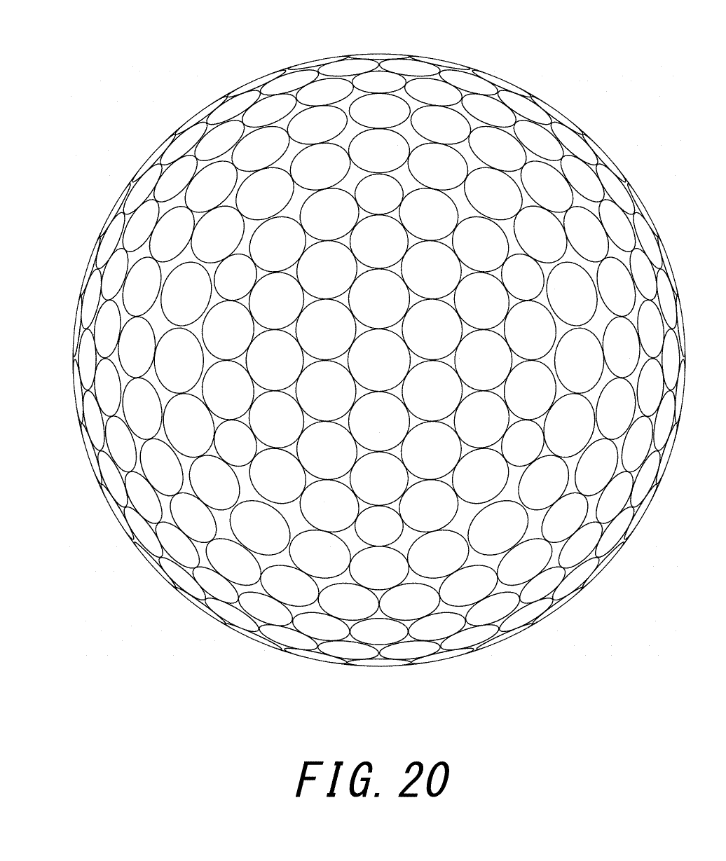

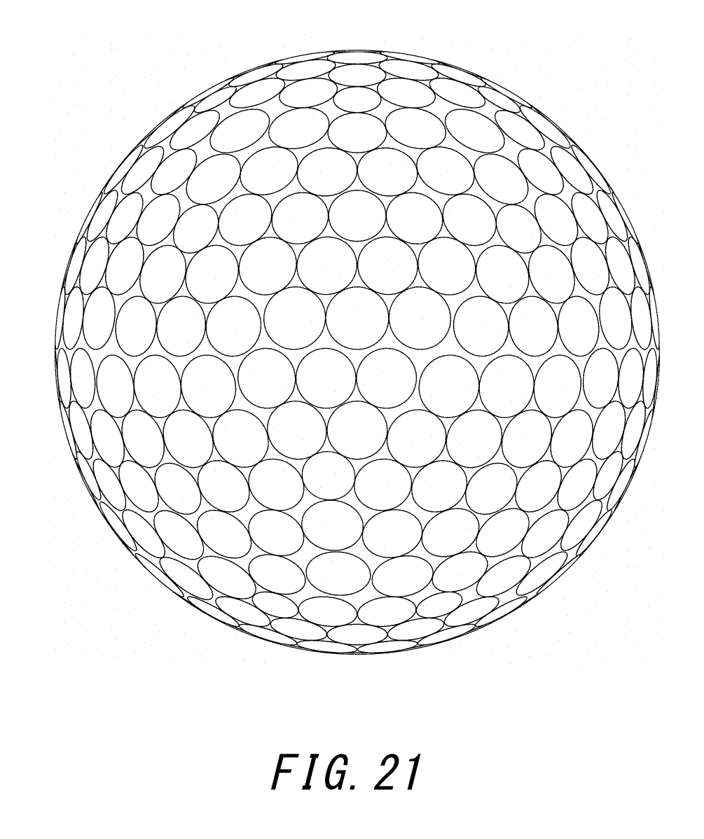

TABLE 8
Specifications of Dimples

| | D5 | D6 | D7 |
|---|---|---|---|
| Plan view | FIG. 16 | FIG. 18 | FIG. 20 |
| Front view | FIG. 17 | FIG. 19 | FIG. 21 |
| Number of dimples | 338 | 330 | 344 |
| Number of units | 3 | 3 | — |
| Number of small | 6 | 6 | — |
| units | | | |
| Occupation ratio | 78.1 | 79.9 | 85.3 |
| So (%) | | | |
| Total volume TV | 490.1 | 529.3 | 592.5 |
| (mm³) | | | |
| Standard | 0.00 | 2.10 | 1.42 |
| deviation Su of S | | | |
| (mm²) | | | |
| Number of | 1,068 | 1,014 | 1,038 |
| neighboring | | | |
| dimple pairs | | | |
| Average of L | 0.434 | 0.375 | 0.190 |
| (mm) | | | |
| Standard | 0.502 | 0.452 | 0.306 |
| deviation Pd of L | | | |
| (mm) | | | |

TABLE 9
Results of Evaluation

| | Ex. 1 | Ex. 2 | Ex. 3 | Ex. 4 |
|---|---|---|---|---|
| Core | I | I | I | I |
| Diameter (mm) | 37.80 | 37.80 | 37.80 | 37.80 |
| Ho (Shore C) | 48 | 48 | 48 | 48 |
| Hs (Shore C) | 80 | 80 | 80 | 80 |
| Inner cover | b | b | b | b |
| T1 (mm) | 0.95 | 0.95 | 0.95 | 0.95 |
| H1 (Shore C) | 57 | 57 | 57 | 57 |
| Main cover | h | h | h | h |
| T2 (mm) | 1.00 | 1.00 | 1.00 | 1.00 |
| H2 (Shore C) | 98 | 98 | 98 | 98 |
| Outer cover | j | j | j | J |
| T3 (mm) | 0.50 | 0.50 | 0.50 | 0.50 |
| H3 (Shore C) | 57 | 57 | 57 | 57 |
| Dimple | D1 | D2 | D3 | D4 |
| Deformation Sb (mm) | 3.21 | 3.21 | 3.21 | 3.21 |
| THs | 76 | 76 | 76 | 76 |
| TH1 | 54 | 54 | 54 | 54 |
| TH2 | 98 | 98 | 98 | 98 |
| TH3 | 29 | 29 | 29 | 29 |
| (TH1 + TH3)/2 | 41 | 41 | 41 | 41 |
| TH2 − THs | 22 | 22 | 22 | 22 |
| (TH1 + TH3)/2/TH2 | 0.42 | 0.42 | 0.42 | 0.42 |
| Ball speed (m/s) | 57.61 | 57.61 | 57.61 | 57.61 |
| Spin (rpm) | 2390 | 2390 | 2390 | 2390 |
| Flight distance (m) | 200.5 | 199.9 | 199.5 | 198.6 |
| Feel at impact | A | A | A | A |

TABLE 10
Results of Evaluation

| | Comp. | Comp. | |
|---|---|---|---|
| | Ex. 1 | Ex. 2 | Ex. 5 |
| Core | I | I | I |
| Diameter (mm) | 37.80 | 37.80 | 37.80 |
| Ho (Shore C) | 48 | 48 | 48 |
| Hs (Shore C) | 80 | 80 | 80 |
| Inner cover | b | b | b |
| T1 (mm) | 0.95 | 0.95 | 0.95 |
| H1 (Shore C) | 57 | 57 | 57 |
| Main cover | h | h | h |
| T2 (mm) | 1.00 | 1.00 | 1.00 |
| H2 (Shore C) | 98 | 98 | 98 |
| Outer cover | j | j | j |
| T3 (mm) | 0.50 | 0.50 | 0.50 |
| H3 (Shore C) | 57 | 57 | 57 |
| Dimple | D5 | D6 | D7 |
| Deformation Sb (mm) | 3.21 | 3.21 | 3.21 |
| THs | 76 | 76 | 76 |
| TH1 | 54 | 54 | 54 |
| TH2 | 98 | 98 | 98 |
| TH3 | 29 | 29 | 29 |
| (TH1 + TH3)/2 | 41 | 41 | 41 |
| TH2 − THs | 22 | 22 | 22 |
| (TH1 + TH3)/2/TH2 | 0.42 | 0.42 | 0.42 |
| Ball speed (m/s) | 57.61 | 57.61 | 57.61 |
| Spin (rpm) | 2390 | 2390 | 2390 |
| Flight distance (m) | 193.1 | 194.0 | 197.3 |
| Feel at impact | A | A | A |

TABLE 11
Results of Evaluation

| | | Comp. | Comp. | Comp. | |
|---|---|---|---|---|---|
| | Ex. 6 | Ex. 3 | Ex. 4 | Ex. 5 | Ex. 7 |
| Core | I | I | I | I | I |
| Diameter (mm) | 37.80 | 37.80 | 37.80 | 36.60 | 37.30 |
| Ho (Shore C) | 48 | 48 | 48 | 48 | 50 |
| Hs (Shore C) | 80 | 80 | 80 | 79 | 80 |
| Inner cover | b | b | b | a | c |
| T1 (mm) | 0.95 | 0.95 | 0.95 | 0.95 | 0.95 |
| H1 (Shore C) | 57 | 57 | 57 | 50 | 63 |
| Main cover | f | e | e | g | g |
| T2 (mm) | 1.00 | 1.00 | 1.00 | 1.60 | 1.00 |
| H2 (Shore C) | 92 | 88 | 88 | 96 | 96 |
| Outer cover | j | j | j | j | l |
| T3 (mm) | 0.50 | 0.50 | 0.50 | 0.50 | 0.75 |
| H3 (Shore C) | 57 | 57 | 57 | 57 | 70 |
| Dimple | D1 | D2 | D6 | D5 | D1 |
| Deformation Sb (mm) | 3.41 | 3.51 | 3.51 | 3.21 | 3.24 |
| THs | 76 | 76 | 76 | 72 | 75 |
| TH1 | 54 | 54 | 54 | 48 | 60 |
| TH2 | 92 | 88 | 88 | 154 | 96 |
| TH3 | 29 | 29 | 29 | 29 | 53 |
| (TH1 + TH3)/2 | 41 | 41 | 41 | 38 | 56 |
| TH2 − THs | 16 | 12 | 12 | 81 | 21 |
| (TH1 + TH3)/2/TH2 | 0.45 | 0.47 | 0.47 | 0.25 | 0.59 |
| Ball speed (m/s) | 57.36 | 57.27 | 57.27 | 57.64 | 57.65 |
| Spin (rpm) | 2490 | 2502 | 2502 | 2615 | 2537 |
| Flight distance (m) | 197.3 | 196.1 | 193.8 | 195.5 | 198.9 |
| Feel at impact | A | B | B | D | B |

TABLE 12
Results of Evaluation

| | Comp. | Comp. | | | Comp. |
|---|---|---|---|---|---|
| | Ex. 6 | Ex. 7 | Ex. 8 | Ex. 9 | Ex. 8 |
| Core | II | II | II | II | II |
| Diameter (mm) | 37.30 | 35.70 | 36.60 | 37.10 | 37.10 |
| Ho (Shore C) | 58 | 56 | 56 | 56 | 56 |
| Hs (Shore C) | 77 | 74 | 75 | 76 | 76 |
| Inner cover | d | b | b | b | b |
| T1 (mm) | 0.95 | 0.95 | 0.95 | 0.75 | 0.75 |
| H1 (Shore C) | 76 | 57 | 57 | 57 | 57 |
| Main cover | f | g | g | g | g |
| T2 (mm) | 1.00 | 1.80 | 1.60 | 1.30 | 1.30 |
| H2 (Shore C) | 92 | 96 | 96 | 96 | 96 |
| Outer cover | k | j | j | j | j |
| T3 (mm) | 0.75 | 0.75 | 0.50 | 0.75 | 0.75 |
| H3 (Shore C) | 63 | 57 | 57 | 57 | 57 |
| Dimple | D3 | D6 | D2 | D3 | D5 |
| Deformation Sb (mm) | 3.24 | 3.11 | 3.16 | 3.26 | 3.26 |
| THs | 72 | 66 | 69 | 70 | 70 |
| TH1 | 72 | 54 | 54 | 43 | 43 |
| TH2 | 92 | 173 | 154 | 125 | 125 |
| TH3 | 47 | 43 | 29 | 43 | 43 |
| (TH1 + TH3)/2 | 60 | 48 | 41 | 43 | 43 |
| TH2 − THs | 20 | 107 | 85 | 54 | 54 |
| (TH1 + TH3)/2/TH2 | 0.65 | 0.28 | 0.27 | 0.34 | 0.34 |
| Ball speed (m/s) | 57.7 | 57.83 | 57.74 | 57.63 | 57.63 |
| Spin (rpm) | 2742 | 2658 | 2602 | 2564 | 2564 |
| Flight distance (m) | 195.6 | 195.8 | 198.2 | 197.3 | 195.9 |
| Feel at impact | B | D | C | A | A |

As shown in Tables 9 to 12, the golf ball of each Example has excellent flight performance and feel at impact. From the evaluation results, advantages of the present invention are clear.

The golf ball according to the present invention is suitable for, for example, playing golf on golf courses and practicing at driving ranges. The above descriptions are merely illustrative examples, and various modifications can be made without departing from the principles of the present invention.

What is claimed is:

1. A golf ball comprising a core, an inner cover positioned outside the core, a main cover positioned outside the inner cover, and an outer cover positioned outside the main cover, wherein
a product TH2 of a thickness T2 (mm) and a Shore C hardness H2 of the main cover and a product THs of a value of 5% of a radius (mm) of the core and a Shore C hardness Hs at a surface of the core satisfy the following mathematical formula,
15≤(TH2−THs)≤100
a product TH1 of a thickness T1 (mm) and a Shore C hardness H1 of the inner cover, a product TH3 of a thickness T3 (mm) and a Shore C hardness H3 of the outer cover, and the product TH2 satisfy the following mathematical formula,
0.25<((TH1+TH3)/2)/TH2<0.65
the golf ball has a plurality of dimples on a surface thereof,
a standard deviation Su of areas of all the dimples is not greater than 1.70 mm², and
a standard deviation Pd of distances L between dimples of all neighboring dimple pairs is less than 0.500 mm.

2. The golf ball according to claim 1, wherein
the thickness T2 is equal to or larger than the thickness T1, and
the thickness T2 is equal to or larger than the thickness T3.

3. The golf ball according to claim 1, wherein the thickness T2 is not less than 1.00 mm.

4. The golf ball according to claim 1, wherein the thickness T1 is not greater than 1.00 mm, and the thickness T3 is not greater than 1.00 mm.

5. The golf ball according to claim 1, wherein the hardness H2 is not less than 93.

6. The golf ball according to claim 1, wherein the hardness H1 is not greater than 70, and the hardness H3 is not greater than 70.

7. The golf ball according to claim 1, wherein the standard deviation Su is not greater than 1.50 mm².

8. The golf ball according to claim 1, wherein the standard deviation Pd is not greater than 0.400 mm.

9. The golf ball according to claim 1, wherein a ratio So of a sum of the areas of the dimples relative to a surface area of a phantom sphere of the golf ball is not less than 78.0%.

10. The golf ball according to claim 1, wherein a sum of volumes of all the dimples is not less than 450 mm³ and not greater than 750 mm³.

11. The golf ball according to claim 1, wherein
a dimple pattern of each hemisphere of a phantom sphere of the golf ball includes three units that are rotationally symmetrical to each other, and
a dimple pattern of each unit includes two small units that are mirror-symmetrical to each other.
